(19) United States
(12) Patent Application Publication
(10) Pub. No.: US 2026/0023253 A1
(43) Pub. Date: Jan. 22, 2026

(54) Three-Dimensional Two Photon Miniature Microscope Brain Imaging in Freely-Behaving Animals

(71) Applicant: REGENTS OF THE UNIVERSITY OF MICHIGAN, Ann Arbor, MI (US)

(72) Inventors: Thomas D. Wang, Ann Arbor, MI (US); Sung Eun Kwon, Ann Arbor, MI (US); Haijun Li, Ann Arbor, MI (US); Kenn Oldham, Ann Arbor, MI (US); Tayebeh Sahraeivelverdi, Ann Arbor, MI (US)

(21) Appl. No.: 18/993,931

(22) PCT Filed: Jul. 11, 2023
(86) PCT No.: PCT/US23/27429

§ 371 Date: Jan. 13, 2025

Related U.S. Application Data
(60) Provisional application No. 63/388,167, filed on Jul. 11, 2022.

(51) Int. Cl. G02B 21/00

(52) U.S. Cl. CPC G02B 21/0076; G02B 21/0032; G02B 21/0036; G02B 21/006; G02B 2207/114

(57) ABSTRACT

An implantable multi-photon optical probe includes a probe housing having a proximal end and a distal end implantable on a sample. The probe housing adapted to provide excitation energy to the sample and to collect emitted radiation from the sample. The probe housing includes scanning optics configured to receive excitation radiation, and to laterally and axially scan the excitation radiation over a field-of-view of the optical probe. A scanning lens is disposed in the probe housing configured to receive the excitation radiation from the scanning optics, and an objective lens reshapes and focuses the excitation radiation. A focusing lens is disposed to receive the excitation radiation and to focus the excitation radiation into the sample.

### FIELD OF THE INVENTION

The disclosure relates generally to methods and systems for imaging tissue using an optical instrument, and specifically performing high spatiotemporal multi-photon imaging using microelectromechanical systems.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Imaging of biological fluids, tissues and other soft biomaterials is important for basic scientific research, engineering applications, and clinical diagnostics. Endomicroscopes are typically used to scan objects in a horizontal plane, parallel to a surface of a tissue. However, a vertical plane (also referred to herein as an axial plane or an into-tissue plane) can be more useful for imaging biological structures and processes that develop perpendicular to the tissue surface, processes such as normal epithelial development, stem cell migration, neural pathways, and tumor invasion. The desire to image the vertical plane of in vivo biological structures and processes has motivated the development of a number of designs for miniature instruments including multi-photon microscopy devices. However, none of the previous designs provide for axial displacement and scan speed needed to generate real-time cross-sectional images of deep tissue neural pathways and connections in brain tissue, and none of the previous designs do so in a useful form factor that does not seriously harm the specimen. Conventional endomicroscopes, for example, are bulky and cannot repetitively pass into regions to be imaged such as the brain.

Multi-photon microscopy offers both high resolution and significant imaging depth using intense pulses of long wavelength light that are capable of penetrating beneath the image surface to excite shorter wavelength photons via nonlinear effects. Relative to other deep tissue optical imaging modalities, multi-photon microscopy has benefits of reduced photobleaching and capacity to excite endogenous fluorescence in addition to its compatibility with a variety of targeted fluorescent biomarkers. Despite a number of miniature multi-photon instruments, there is a need for endomicroscopes that can image deep into tissue with axial beam scanning. Existing systems capable of deep imaging utilize conventional bench top microscopes and thus increase experimental complexity, study invasiveness, and biological behavior. Further,

To best make use of multi-photon imaging capabilities in a small instrument, it is desirable to support fast axial (i.e., vertical or into-tissue) scanning of an ultrafast laser. Sufficiently fast axial scanning can support in vivo vertical optical sectioning, thereby providing real-time cross-sectional images of tissue in the same plane that is used by histologists to diagnose and monitor diseases such as colon or esophageal cancer. However, previous endoscopic instruments have provided limited support for altering depth-of-focus during multi-photon imaging. Several en face multi-photon endoscopes have characterized out-of-plane, or z-axis, resolution, but only by physically moving the sample being imaged. When moving in the z-axis, it is of particular importance to maintain a level imaging plane in order to provide for a clear image. To create an image in the vertical plane, a series of horizontal plane images are acquired and then reconstructed. This approach is usually slow and difficult to accomplish, as vibrations in the sample may cause motion artifacts. Further, some current three-dimensional imaging systems employ fiber bundles and electrowetting lenses to image in three axes. These systems have limited frame rates, limited spatial resolutions, and limited field-of-vies due to the physical limitations of the fiber bundle and electrowetting optic.

Current tools for tracking neuron activity in moving animals lack the ability to track the same neurons over sustained periods of time in 3D space at millisecond scales. Observing neuronal signal events requires sub-millisecond temporal resolutions and are therefore not accessible using current technologies. For instance, neural probes can track large numbers of neurons, but are not capable of tracking of a same set of neurons over multiple days. Optical microscopes used in observing moving or freely-behaving animals typically only image a fixed 2D plane at a time. Some 3D imaging instruments employ tunable lenses, which are limited in response time, temporal resolution, and spatial resolution. As such, current imaging modalities cannot achieve cellular-level resolution of a 3D volume of a sample for observing cellular, and sub-cellular, level activity.

A miniaturized and implantable version of such an imaging tool could provide real-time and dynamic scanning images that allow repeated examination of a same area without causing damage. Such systems can be used to monitor progression and treatment outcomes for diseases and drug delivery monitoring. Furthermore, an implantable, low weight, and compact version can be mounted on small freely-behaving animal such as a mouse in neuroscience studies. A limitation of most implantable microscopes is that they have limited working distance and field-of-view (FOV). Additionally, most endoscopic systems use bulky fiber bundles to deliver and collect light which limits the flexibility of the system and adds weight, which may harm or damage an animal or subject being imaged. Laser scanning at distal optics, in which a movable mirror is used to steer a laser close to the microscope objective, generally offers largest FOV without excessive optical aberrations. Microelectromechanical system (MEMS) micro-mirrors can provide such scanning in small, fiber-coupled microscopes. However, constraints on a MEMS mirror's range-of-motion and operating frequency introduce additional trade-offs in overall instrument performance. As such, there is need for a light-weight, compact, endoscopic system for performing real time axial and lateral imaging of freely behaving animals and subjects.

### SUMMARY OF THE INVENTION

The present application describes a handheld optical device that may be used as a microscope system for real-time, 3D optical imaging. Systems for a multi-photon endomicroscope utilize miniature vertical actuators to provide for fast axial scanning in addition to large axial (i.e., vertical) displacement using miniaturized equipment. Vertical actuation is obtained using either electrostatic, thin-film piezoelectric, or electrothermal actuators in conjunction with multi-photon imaging modalities. Axial scanning is achieved based on translation of a rigid mirror using piezoelectrically-actuated actuators, electrothermally-actuated actuators, or electrostatic actuation under parametric resonance, each of which can achieve high speed and large displacement scanning with appropriate scanner design. Moreover, this axial scanning (i.e., along the Z-axis) is combinable with a lateral scanning, also based on piezoelectric actuation or electrostatic actuation at parametric resonance, that is able to scan a beam above different planar axes (i.e., the X-axis and the Y-axis). Moreover still, this lateral scanning can be achieved at different axial scanning depths, without changes in scan performance. The use of different resonant modes for the axial scanner from that of the lateral scanner, or DC modes when operated with piezoelectric or electrothermal actuation, further allows for better isolated control of scanning in different directions.

Multi-photon imaging offers a number of benefits for real-time, in vivo imaging of the epithelium and other regions compared to confocal imaging. For example, multi-photon imaging can provide greater image depth, less photo bleaching for longer term imaging studies, and can also provide for increased image resolution or reduced scattering. While dual axes confocal microscopy has shown potential for comparable imaging depth and resolution with vertical sectioning, larger instrument diameters are required for equivalent depth due to the need to provide light paths at off-axis angles. Because a single excitation wavelength can excite multiple fluorophores, multiplexing is substantially easier with multi-photon imaging than in other imaging modalities such as magnetic resonance imaging (MRI) and positron emission tomography (PET). Further, multi-photon excitation produces reduced photo damage and out-of-plane photo bleaching than other techniques. Multi-photon systems use a single optical path for both incident and returning light (though the path may be split off for collection purposes), and accordingly, as compared to dual axes imaging systems, use a round mirror geometry (as opposed to a generally dogbone geometry used by dual axes). Further, the lens arrangement in dual-axes systems require precise alignment of two collimating lenses using a mechanism such as a parabolic fixed mirror to ensure the separate beam paths align at the same point. Multi-photon arrangements do not have this alignment issue, though these systems require an appropriate relay lens configuration to map changes in axial displacement of the scanning mirrors to displacement of the focal point in tissue. One advantage of the present techniques is that imaging can occur without the need of fluorescent markers using endogenous fluorescence of tissues and/or cells.

The systems of the present application provide for real-time, axial or vertical scanning into the tissue, using mirror scanning approaches. This axial movement of the mirrors may be performed using thin-film piezoelectric, electrothermal, and/or electrostatic actuators, which can provide substantial displacement (e.g., approximately 500 microns) while still having a small diameter (e.g., approximately 3 mm). Thin-film piezoelectric actuators can create larger axial translation at lower operating voltages as well as the ability to individually address actuating legs to compensate for non-uniform motion. Electrothermal actuators offer large displacement and improved linearity, but lower scanning speeds. Electrostatic actuators are relatively simple to fabricate and function at higher operating speeds. Additionally, if the mirror surface is built monolithically (i.e., as a single component), the device will have better initial uniformity.

The present multi-photon imaging system uses a two-photon effect, which occurs when two lower energy (i.e., longer wavelength) photons arrive at a biomolecule simultaneously to excite fluorescence. The probability of absorbing two photons increases with the square of intensity; thus, a high numerical aperture objective in the single axis configuration is used to maximize the intensity at the focus. Because of this physical principle, there is less sensitivity to tissue scattering and reduced photobleaching when compared to single photon fluorescence. Additionally, the longer excitation wavelengths used provides deeper tissue penetration.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a schematic diagram of a multi-photon optical imaging system with implanted optics and a benchtop portion.

FIG. 2A is a perspective view of probe housing for containing the implanted optics of FIG. 1.

FIG. 2B is a photograph of a mouse having a portion of exposed brain for imaging and a probe unit physically mounted on the mouse.

FIG. 2C is an image showing the housing of FIG. 2A mounted onto a probe mount to secure the housing to the probe mount for imaging the brain of a mouse.

FIG. 3 illustrates a lateral MEMS stage with a mirror that is formed as part of a lateral actuator system for scanning radiation across a sample.

FIG. 4 illustrates a design for an axial MEMS stage for controlling the working distance of a compact microscope in accordance with various embodiments.

FIG. 5A is a ray diagram of the path of excitation radiation through the implanted optics of FIG. 1 implanted optics along the path of the excitation radiation.

FIG. 5B is a ray diagram of the excitation radiation path with an axial MEMS stage at three different positions.

FIG. 5C is a ray diagram showing three different imaging planes resulting from the axial MEMS stage positions of FIG. 5B.

FIG. 5D is a ray diagram of the path of emitted radiation through the implanted optics of FIG. 1.

FIG. 6 summarizes Zemax ray simulation results for an implantable microscope.

FIG. 7 presents a series of ray spot diagrams illustrating the spot sizes of the simulated results of FIG. 6.

FIG. 8 is a plot of detected radiation intensity for determining lateral resolution via a knife edge test.

FIG. 9 is a plot of detected radiation intensity for determining axial resolution of an implantable microscope.

FIG. 10 is a schematic diagram of implanted optics for a single MEMS stage multi-photon optical imaging system.

FIG. 11 is an example block diagram illustrating various components used in implementing an example embodiment of an implantable thin-film piezoelectric multi-photon microscope system.

FIG. 12 is an example schematic diagram of a miniaturized multi-photon optical imaging system with miniaturized remote z-scanning using implanted optics and a benchtop portion.

FIG. 13A is a simulated ray diagram showing various elements of the implanted optics 1205 of FIG. 12 and the optical path of the excitation radiation.

FIG. 13B is a simulated ray diagram showing the optical path of emitted fluorescence light through the implanted optics of FIG. 12.

FIG. 14A is an example Point Spread Function (PSF) for excitation radiation at a working distance of 20 μm.

FIG. 14B is an example PSF for excitation radiation at a working distance of 250 μm.

FIG. 14C is an example PSF for excitation radiation at a working distance of 350 μm.

FIG. 15A is an example spot diagram for excitation radiation at a working distance of 20 μm.

FIG. 15B is an example spot diagram for excitation radiation at a working distance of 250 μm.

FIG. 15C is an example spot diagram for excitation radiation at a working distance of 350 μm.

FIG. 16 illustrates an assembly and test setup of a miniaturized two-photon, three-dimensional (3D) imaging system.

FIG. 17 illustrates a diagram of an optical path through the assembly of the miniaturized two-photon, 3D imaging system of FIG. 16.

FIG. 18A is a simulated ray diagram of a focused beam using an axial scanning MEMS device.

FIG. 18B is a simulated ray diagram of a focused beam using a lateral scanning MEMS device.

FIG. 18C is a simulated ray diagram of a focused beam using a combined axial-lateral scanning MEMS device.

FIG. 19 is a table showing the working distance, numerical aperture, field of view, and the scanner geometries for axial z-scanners at different axial scanner locations.

FIG. 20A is a block diagram of implantable optics with excitation radiation provided by a Ti:Sapphire laser and single optical path that utilizes a single optical fiber to provide excitation radiation and collect emitted radiation.

FIG. 20B is a simulated ray diagram of the objective lens and various lateral MEMS stage positions of the implantable optics of FIG. 20A.

FIG. 20C is a simulated ray diagram of the objective lens and various axial MEMS stage positions of the implantable optics of FIG. 20A.

FIG. 20D is a table presenting lateral scan angles with corresponding lateral focus distances or coordinates, and axial MEMS positions with corresponding working distances and numerical apertures for the implantable optics of FIG. 20A.

FIG. 21 shows a plurality of ex-vivo images of a Thy1-YFP mouse sample tissue remote axial scanning, with each image taken at different focal distance depth in the tissue sample.

FIG. 22A presents a volumetric image reconstruction of the axial imaging scan presented in the plurality of images of FIG. 21.

FIG. 22B presents a side view of the volumetric image reconstruction presented in FIG. 22A.

FIG. 22C presents a second side view of a different vertical slice of the volumetric image reconstruction of FIG. 22A.

FIG. 22D presents a top view of the volumetric image reconstruction presented in FIG. 22A.

FIG. 23A is an example image of a brain tumor sample with green fluorescent protein (GFP) GFP expression using the multi-photon imaging systems described herein.

FIG. 23B is another example image of a brain tumor sample with green fluorescent protein (GFP) GFP expression.

FIG. 23C is another example image of a brain tumor sample with green fluorescent protein (GFP) GFP expression.

FIG. 23D is another example image of a brain tumor sample with green fluorescent protein (GFP) GFP expression.

FIG. 23F is another example image of a brain tumor sample with green fluorescent protein (GFP) GFP expression.

FIG. 24 presents ex-vivo images of a confetti mouse fallopian tube animal sample using excitation radiation with wavelengths of 1050 nm, 920 nm, 965 nm, and 837 nm.

FIG. 25 is an example schematic diagram of another miniaturized multi-photon optical imaging system with miniaturized remote z-scanning using implanted optics and a benchtop portion, configured for air-coupling.

### DETAILED DESCRIPTION

The present application provides techniques for performing endoscopic measurements using an implantable reflectance confocal and/or multi-photon microscope with a long working distance. Confocal laser scanning microscopy is an optical imaging technique that uses a spatial pinhole to block out-of-focus light. Reflectance confocal microscopy (RCM) is a non-invasive label free biomedical imaging technique which is attracting for its simplicity and low cost. RCM works based on natural refractive properties of cellular and subcellular structures. For example, in brain imaging phospholipids in myelin appear brighter than axons because of their higher refractive index. Similarly, mitochondria inside the axon appears darker than its myelin covering. RCM applications include but are not limited to imaging in brain, skin, bone, teeth, and eye tissues.

For brain-related applications RCM has demonstrated in vivo imaging of myelinated axons at about 400 μm depth in the wavelength range of 400-600 nm. Therefore, development of deep RCM for clinical and preclinical applications such as monitoring metallic nano particles in the skin and brain in drug delivery studies is of interest. Moreover, this technique can be applied to blood flow and blood cell monitoring and early cancer detection. The described device utilizes microelectromechanical systems (MEMS) mirrors coupled to achieve diffraction limited resolution over a wide field-of-view (FOV). The described system is capable of providing 1.3 micron, 1.5 micron, and 6 micron axial resolution with a 500 micron by 500 micron FOV, with up to a 550 micron working distance. Previous 3D brain imaging systems utilize fiber bundles to deliver and collect light. The fiber bundles are stiff structures that constrain movement of an animal or living subject. Further, images are degraded by the honeycomb pixelated pattern of the fiber bundles. Additionally, the FOV of such systems is limited by the number of fibers in the bundle, these systems exhibit low frame rates, and typically utilize high-power large scanners. Also, the scanner is typically far from the sample being images which reduces the temporal resolution and frame rate and there can be large dispersion in the fiber bundle further reducing resolution both spatially and temporally. The disclosed imaging system does not employ a fiber bundle, and therefore, overcomes all of these challenges allowing for miniaturized 3D imaging at higher spatial and temporal resolutions in real time.

The disclosed device includes a miniaturized microscope system for performing three-dimensional (3D) imaging of tissue in freely-behaving animals. The device provides high spatiotemporal images at fast imaging rates allowing for real time imaging of biological structures and processes. Further, high image sampling rates can also be performed for localized regions within the 500×500×550 μm³ sample volume. As described herein, the use of MEMS mirrors allows for three-axis scanning with both increased lateral and axial resolution as compared to current technologies. The three-axis scanning includes fast scanning in the axial direction for imaging across full volumes, and random-access control of all axes to select imaging planes and increase the image sampling rate at arbitrary, local regions within the full field-of-view (FOV).

Addition of random-access control of the MEMS scanners enables higher

spatiotemporal resolution at arbitrary regions of interest (ROIs) within the full volume. Using the random-access control of the MEMS devices allows cross-sectional imaging at multiple locations of the FOV in a single frame. However, it also permits laser scanning beyond nominal mirror bandwidth, which results in a reduced FOV at a higher imaging frame rate centered on arbitrary points within the imaging space. For the fabricated device described herein, the imaging can be performed for a full FOV at a nominal frame rate of 20 Hz, to a frame rate of 200-500 Hz at a ROI approximately 10-100 μm in dimension. Increased sampling rates in small regions allows for the observation of fast biological and electrical processes such as action potential propagation across cortical layers in tethered animals, which has not been previously accomplished using other imaging systems.

The described scanning approach ensures that cellular-level resolution can be maintained while performing multi-photon imaging across substantial imaging depth. The ability to monitor neuronal population activity across multiple layers near simultaneously enables important new experiments not currently possible with existing imaging technologies. The use of MEMS scanning mirrors based on thin-film piezoelectrics, and a folded optical path, allow for the reduction of heavy components resulting in an implantable device that does not harm or provide stress to an animal or biological subject, and limits scanner movement sensitivity to motion artifacts from the moving animal. Two-photon imaging is used in the described method to perform deep tissue imaging for performing in vivo, noninvasive 3D brain imaging at cellular and subcellular resolutions. Using multi-photon imaging allows for the use of separate optical fibers for providing the light to the microscope, and for light collection. The ability to use two different optical paths via separate optical fibers does not require a special polarization-maintaining fiber to deliver excitation light, unlike other 3D-imaging designs. Therefore, the separate optical paths of excitation radiation, and emitted radiation further allows for the simplification of the system, and reduction of size and total cost.

As described herein, implantable may describe an element or probed that is entirely implanted inside of a subject such as a human or animal, or entirely inside of an organ or tissue for imaging of tissues in the sample, organ or tissue. Alternatively, the term implanted should also be understood to mean an element or probe that is implanted onto a subject. For example, an implantable probe may be a probe that is physically attached to a part of a subject, such as attached to a skull of a mouse, for imaging tissues of the subject. Further, an implanted probe or microscope may include some components that are implanted inside of a subject, organ, or region of tissue, while other elements of the implanted probe are external to the subject, organ, or region of tissue.

Implantable microendoscopes offer repetitive imaging of the same tissue at frequent intervals over extended periods. Such devices can be placed in fixed locations relative to tumors, collect images in real-time, and achieve cellular-to-sub-cellular resolutions. With typical implantable microendoscopre systems, the field-of-view (FOV) is limited and most microendoscopes are only capable of imaging in a 2D horizontal plane. These systems often require the adjustment of optical fiber positions within a probe which is very slow and is over discrete intervals. In other approaches, electroactive lenses have been implemented to adjust working distance (WD), but this causes increased optical aberrations and has a limited axial field-of-view. The proposed implantable imaging systems provide enhanced FOV, over large WDs while also providing a compact and implantable design.

The disclosed microendoscope designs leverage objective lenses with large WDs and scanner placement in close proximity to maintain cellular-level lateral and axial resolution achieving both a wide lateral FOV and large axial range (up to 650×500×400 μm³), with flexibility in distal optics for selection of nominal imaging depth. In an example implementation, the disclosed microendoscope uses a folded beam path in which incident light from a fiber is reflected off an axial scan mirror surface before being relayed to an objective. A single path endoscope design is also disclosed in which scanning is performed using a single optical path aligned with a narrow GRIN lens. The single path endoscope design is capable of imaging depths between 1.0 and 1.3 mm in mouse brain tissue with 1.0-2.0 μm lateral, and 9.0-12 μm axial resolution over an approximately a 440×300×300 μm³ FOV.

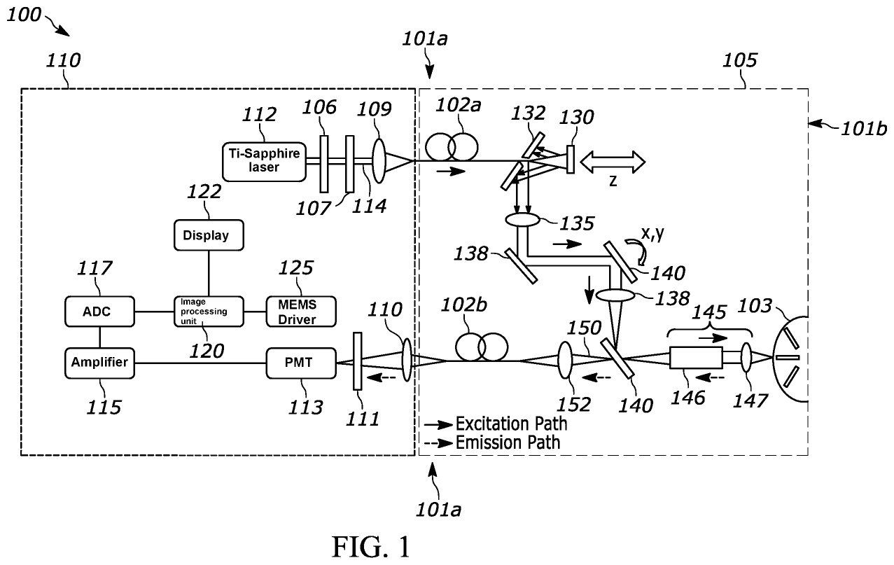

FIG. 1 is a schematic diagram of a multi-photon optical imaging system 100 with implanted optics 105 and a benchtop portion 110. The implanted optics 105 are components that are implanted into a biological subject for imaging of tissues in the subject. For example, the subject may be a mouse and the implanted optics 105 may be physically positioned to image brain tissues of the mouse. The implanted optics 105 may be contained in a housing (not illustrated) that receives and transmits through ports in a proximal side 101a of the optics, 105 and is physically connected to the subject or mouse via a distal side 101b of the implanted optics. As used herein, the term “downstream” indicates a component that is further along an optical path than an “upstream” component along the same propagation of radiation. The target for imaging will be referred to as a sample 103. The implanted optics 105 include an axial MEMS scanning unit or stage 130, a lateral MEMS scanning unit or stage 140, and an objective 145. The lateral scanning unit 140 is adapted to scan the output laser energy over a planar scan area of the sample 103 by moving a lateral mirror assembly, and the axial scanning stage 130 includes an axial mirror assembly and is adapted to scan the output laser energy over an imaging depth range of the sample. The axial and lateral MEMS stages 130 and 140 may together be referred to as scanning optics herein. The imaging depth range and the planar scan area combine to form a three-dimensional volume, also known as an imaging voxel. The imaging depth may also be referred to herein as a focal distance, focal depth, depth of range, working range, working depth, or working distance of the imaging system 100. The axial scanning unit 140, lateral scanning unit 130, and objective 145 are all optically coupled to laser and light collection electronics via input and output fiber optic cables 102a, 102b. As illustrated, the input fiber optic cable 102a is the further upstream component of the implanted optics, while the output fiber optic cable 102b is the furthest downstream component of the implanted optics. Any number of these components can be at least partially disposed in a single, handheld probe housing frame (not illustrated), with the probe housing being implanted into the subject.

As used herein, “benchtop” (as in “benchtop portion”) refers to a structure, component, assembly, or otherwise that is positioned externally from a subject and is optically, electrically, or otherwise communicatively coupled to an implanted portion. That positioning can include being placed upon, mounted to, or integrated with any suitable worksurface, for example. The benchtop portion 110 includes laser and light collection electronics such as a Ti-Sapphire laser 112 with a tunable spectral range of approximately 690-1040 nm. This laser 112 delivers excitation radiation 114 with approximately 100 fs pulse width at 80 MHz. The pulse duration may be minimized using a dispersion pre-compensation unit located inside the laser housing. A half wave plate 106 is used with a linear polarizer 107 to adjust laser power. A lens 109 couples the excitation radiation 114 into the optical fiber 102 to provide the excitation radiation 114 to the implanted optics 105. The benchtop portion 110 further includes light collection optics to receive and detect the light from the implanted optics 105. A lens 110 collects the light from the output optical fiber 102b, a bandpass filter 111 filters the light to remove any noise, and a detector 113 then detects the light. The detector 113 may be a photomultiplier tube, a photodiode, or another detector capable of detecting optical radiation. While a Ti-Sapphire laser was used in implementation, other light sources and imaging processes could be used. For example, a radiation source with excitation radiation wavelengths of up to 1200 nm or 1300 nm could be implemented as the laser 112 for performing three-photon imaging.

The benchtop portion 110 includes additional hardware components for processing and displaying images. For example, an amplifier 115 may receive an electrical signal indicative of an image or a pixel from the detector 113. The amplifier 115 provides an amplified signal to an analog-to-digital converter 117 (ADC). The ADC 117 provides a digital signal to an image processing unit 120. The image processing unit 120 performs image processing to construct images from the digital signal. The image processing unit 120 may provide image data to a display 122 and the display 122 may present images to a user. The image processing unit 120 may also provide information to a MEMS driver 125. Depending on the received signal, the MEMS driver may control the positions and/or orientations of the axial and lateral MEMS stages 130 and 140.

Once the excitation radiation 114 has been coupled to the input optical fiber 102a, the excitation radiation 102a is provided to the axial MEMS stage 140 through an aperture in a mirror 132. The mirror 132 is included in the optical path so that the input optical fiber 102a can be affixed to the subject or animal perpendicular to the subject (e.g., perpendicular to the surface of the subjects skin, or bone such as surface of the skull.) The perpendicular configured of the input optical fiber 102a reduces the tension on the input optical fiber 102 ferule. The axial MEMS stage 130 reflects the excitation radiation 114 onto the mirror 132 and a first lens 135 performs full or partial collimation of the excitation radiation 114. A mirror 138 reflects the excitation radiation 114 to the lateral MEMS stage 140, and the lateral MEMS stage 140 reflects the excitation radiation 114 to a scan lens 139. The scan lens 139 focuses the excitation radiation 114 onto a dichroic mirror 140.

A compound objective lens 145 further collimates the excitation radiation 114 to a given spot size, and focuses the excitation radiation 114 into the sample 103. In various examples, the compound objective lens 145 combines a graded index (GRIN) lens 146 with an aspheric focusing lens 147 to achieve a desired working distance, e.g., a working distance of 303 microns. The GRIN lens 146 provides a large numerical aperture and working distance across a wide range of lateral positions at which the excitation radiation enters the GRIN lens 146. The aspheric lens 147 compensates for spherical aberrations of the GRIN lens, while also further extending the working distance of the probe. The lateral MEMS stage has a ±5° deflection scan angle which results in a field-of-view (FOV) of 400 by 400 μm. In embodiments, the provided optical design may have a FOV of 500 by 500 μm with a working distance of up to 550 μm. In embodiments, the GRIN lens 146 has a 1.8 mm diameter and 4.31 mm length with a numerical aperture of 0.52 and an effective focal length of 1.69 mm. The GRIN lens 146 may have a focal length of less than 1.5 mm, less than 1.7 mm, or less than 2 mm to ensure compact size of the implanted optics 105. Further, the GRIN lens may be a dual wavelength lens to provide similar optical transformations across more than one wavelength region. In embodiments, the aspheric lens 147 has a 2.4 mm diameter, numerical aperture of 0.54, and an effective focal length of 1.45. The aspheric lens may have a focal length of shorter than 1.4 mm. 1.5 mm, or less than 1.8 mm. The GRIN lens 146 and the aspheric lens 147 may each have antireflection coatings such as a visible coating, NIR coating, or broadband antireflective (BBAR) coating to reduce the loss of light through the system.

The specific placement of the various optics in the implanted optics 105 allow for the probe housing 200 to be very compact due to the short distances between components. For example, in one fabricated design, the path length of propagation between the lateral MEMS stage 140 and the GRIN lens 146 is 6 mm, and the distance from the axial MEMS stage 130 to the GRIN lens 146 is 15 mm. This allows for the housing 200 to have a height and width of 15 mm by 15 mm at its broadest cross sections for each dimension. Further, the width and length of the probe housing 200 may be increased or decreased using more or less mirrors to include more propagation in one dimension or the other. In embodiments, the overall size of the probe housing is less than 20 mm by 20 mm, less than 15 by 15 mm, or less than 12 by 12 mm.

The sample 103 includes fluorophores, such as florescent tags or florescent probes, that fluoresce in response to the presence of a biomolecule such as a protein, antibody, or amino acid. The provided excitation radiation 114 causes the florescent tags to fluoresce, providing the emitted radiation 150 from the sample 103 back to the implanted optics 105. The emitted radiation 150 is provided to the lens 147 which collimates the emitted radiation 150 back into the objective lens 145. The emitted radiation 150 passes through the dichroic mirror 140 and a lens 152 focuses the emitted radiation 150 into the output optical fiber 102b. The output optical fiber 102b then provides the emitted radiation 150 to the lens 110 and other components of the benchtop portion 110 for detecting the emitted radiation 150 and generating an image of the sample 103. The input and output optical fibers 102a and 102b may be single mode fibers, multimode fibers, polarization maintaining fiber, or another fiber capable of coupling light into, and out of, the implanted optics 105.

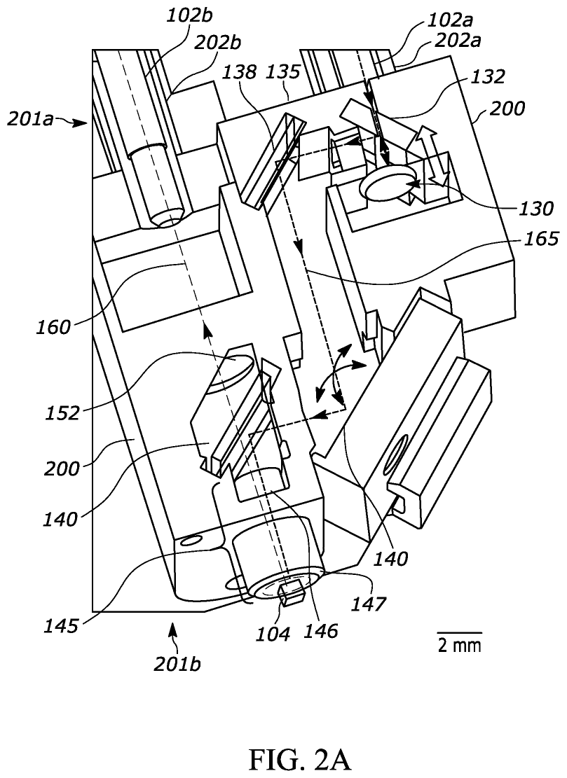

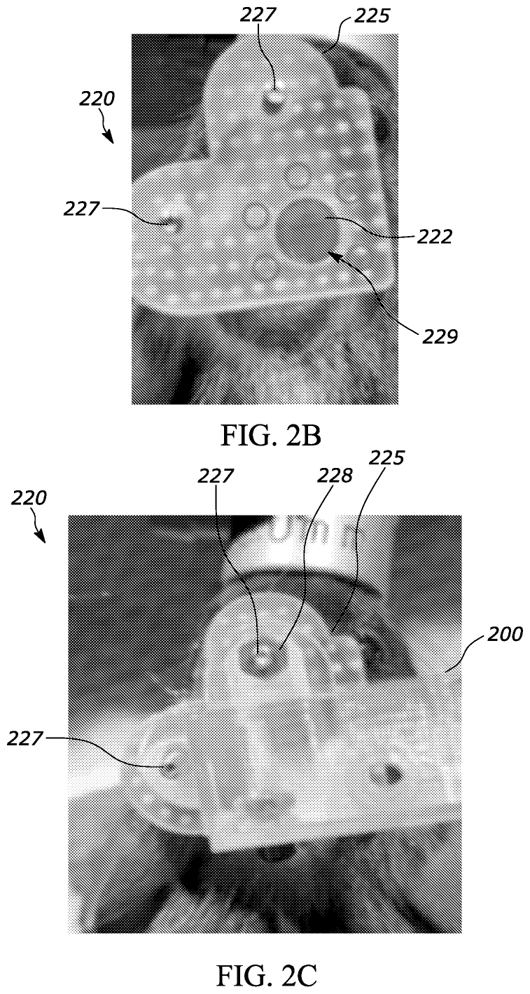

FIG. 2A is a perspective view of probe housing 200 for containing the implanted optics 105 of FIG. 1. The probe housing 200 has a proximal end 201a and a distal end 201b. During operation, the distal end 201b of the probe housing 200 is implanted into the subject such that the implanted optics 105 are positioned to image the sample 103 tissue of the subject. The proximal end 201a of the probe housing 200 includes input and output ports 202a and 202b for the input and output optical fibers 102a and 102b respectively. The input and output ports 202a and 202b are disposed in one or more walls of the housing 200 to allow radiation to pass into and out of the housing 200. The path of the excitation radiation 114 is shown by the excitation path 165, and the path of the emitted radiation 150 is shown by the emission path 160. The input optical fiber 102a injects excitation radiation into the housing 200 through the input port 202a and through an aperture in the mirror 132. The excitation radiation then reflects off of the axial mirror 130, the mirror 132, and the first lens collimates the excitation radiation along the excitation path 165. The axial mirror 130 can translate axially along the path of the propagation of the excitation radiation 114 to focus the excitation radiation at different working distances in the sample 103.

The mirror 138 reflects the excitation radiation to the lateral MEMS stage 140, and the lateral MEMS stage 140 reflects the excitation radiation to the dichroic mirror 140 which reflects the excitation radiation to the objective lens 145. The lateral MEMS stage 140 is configured to tilt a reflective surface to scan the excitation radiation over a FOV of the optical probe. The objective lens 145 reshapes the excitation radiation and focuses the excitation radiation into an imaging volume 104 that includes at least a portion of the sample 103, to image the portion of the sample 103. In applications, the imaging volume 104 may be a single voxel for forming an image of a sample, the imaging volume 104 may be a region of interest within a larger field-of-view or working range of the microscope, or the imaging volume 104 may be an entirety of a sample or volume for imaging.

The excitation radiation excites fluorescent tags in the sample 103, and the fluorescent tags emit radiation back into the lens 147 and into the housing 200 containing the implanted optics 105. The emitted radiation propagates through the objective lens 145 and through the dichroic mirror 140. And the coupling lens 152 focuses the emitted radiation into the output optical fiber 102b to provide the radiation to the benchtop portion of the imaging system.

The housing 200 containing the implanted optics 105 is physically coupled to, or implanted on, a subject to image a volume of tissue of the subject. FIG. 2B is a photograph of a mouse 220 having a portion of exposed brain 222 respectively as the sample for imaging. A probe mount 225 is secured to the skull of the mouse 220 by two mount screws 227. The probe mount 225 has a hole 229 through which the brain 222 of the mouse is exposed. FIG. 2C is an image showing the housing 200, as described with reference to FIG. 2A, mounted onto the probe mount 225 using nuts 228 to secure the housing 200 to the probe mount 225. As such, the implanted optics 105 may be coupled, and decoupled from the subject, or reused for different subjects at different times.

Each of the lateral and axial MEMS stages 140 and 130 may include high energy density PZT thin-films to create MEMS scanning mirrors with large ranges of motion and addressable scanning motions at high bandwidths of operation. The MEMS stages are designed to achieve high-speed, large displacement laser scanning in small spaces, either laterally by rotating a mirror or axially by translating a mirror parallel to the propagation direction of excitation radiation. Among MEMS scanners, large-displacement scanning is typically feasible only in resonance or at low speed by mechanisms such as electrothermal actuation. Thin-film PZT, a high piezoelectric coefficient ceramic material, offers uniquely large driving forces. This permits substantial vertical translation for axial scanners with high bandwidth, which is not achievable by other MEMS scanners. Thin-film PZT scanners can be rapidly translated to specified depths to provide imaging across a 3D volume, or to perform vertical cross-sectional imaging. Vertical plane images may be directly acquired by continuous axial scanning, while scanning with one complementary lateral axis. High energy density thin-films further allows for significant DC offsets in rotational scanning mirrors having high resonant frequencies, which permits video rate imaging across large fields. By manipulating the amplitude of resonance while altering the quasi-static angular offset, thin-film PZT scanners can support random-access scanning to regions-of-interest within the large imaging field, at increased scanning frequencies and frame rates.

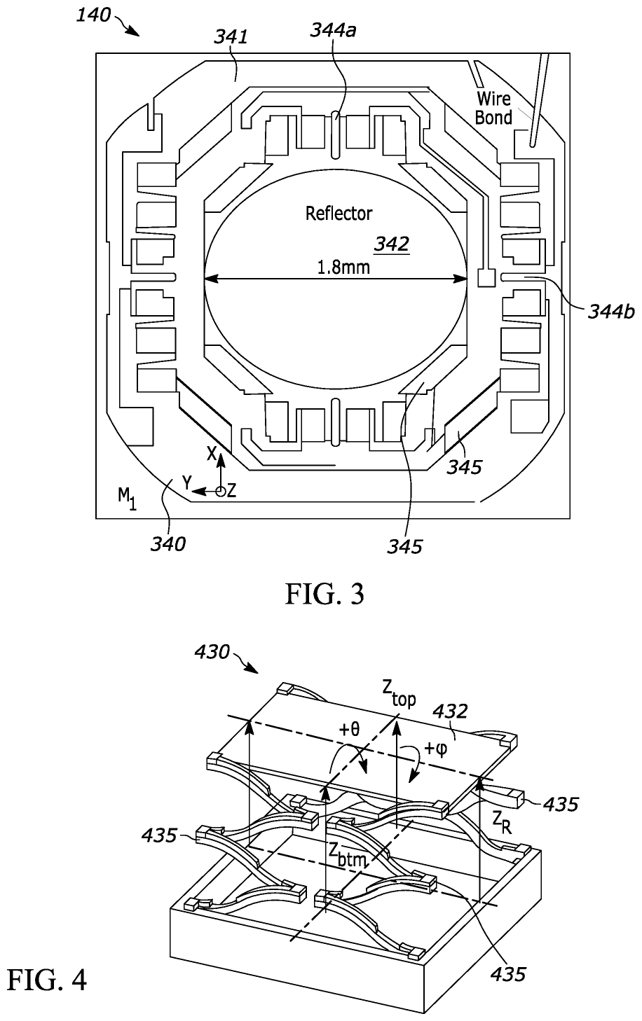

Distinct electrostatic MEMS scanners may be provided for lateral and axial scanning based on the principle of parametric resonance. Large mechanical actuation can be achieved by driving the structure near 2ω0/n, where ω0 is the natural frequency of the scanner and n is an integer ≥1. FIG. 3 illustrates the lateral MEMS stage 140 with a mirror 342 that is formed as part of a lateral actuator system 340 of the lateral MEMS stage 140. While the mirror 342 may take different shapes, in the illustrated example, the mirror 342 is a circular mirror. In the illustrated example, the diameter is 1.8 mm and the mirror 342 is able to accommodate an excitation beam having a width of 1.27 mm width at normal incidence (as opposed to) 45°. The front-side of lateral actuator system 340 was coated with aluminum to achieve reflectivity greater than approximately 85% between approximately 200-900 nm wavelengths to reflect a range of wavelengths for multiphoton excitation.

In the illustrated example, the lateral actuator system 340 includes two actuating axes, about which, the mirror 342 may be independently rotated. An X-axis is defined as shown, aligned with inner leg or spring members of an inner mirror actuator. A Y-axis is defined as aligned with an outer leg of an outer mirror actuator. Each leg is part of an inner and outer comb filter drive, respectively. The comb filter drivers provide electrostatic actuation, such that the mirror 342 rotates around inner (X-axis) and outer (Y-axis) axes, respectively, when driven by drive signals. Each of the inner and outer comb filter drives may be operated at a resonant frequency, e.g., a resonant frequency chosen to be between approximately 1 kHz and approximately 4 kHz, respectively. Furthermore, the system 340 may be driven, with select resonant frequency drive signals to each comb drive, such that the mirror 342 undergoes a sinusoidal scanning pattern. In an example, the system 340 is driven by resonant frequencies to image at ≥5 frame/sec using a Lissajous scanning pattern, and scanning at 400×400 pixels per frame.

Both the inner and outer axes of the lateral actuator system 340 can be actuated to image in the horizontal (XY) plane. The resonant frequencies of these axes were designed to be approximately 1 kHz or 4 kHz, respectively. Further, by combining actuation of the inner axis of the lateral scanner with the out-of-plane motion of an axial scanner, images can be produced in the vertical (XZ) plane. When scanning an object, a dense Lissajous scan pattern is formed that repeats itself at 5 frames per second to generate either horizontal or vertical images with dimensions of 400×400 pixels or 400×320 pixels at 100% coverage. The MEMS scanners are driven via customized software developed in LabView that also reconstructs the image by remapping the time series signal to a 2D image using calibrated motion profiles from the scanner to generate a lookup table. In other words, by knowing where the laser was directed at a particular time, the intensity of the returning laser light can be mapped to form a 2D image. The relationship between the displacement of the axial MEMS stage 130 and the point of focus in the specimen 103 is quantified by mounting the axial actuator on a motorized stage to accurately control position. Advantageously, vertical sections may be collected at approximately 5 frames per second compared to conventional imaging devices which can require several minutes to acquire a stack of horizontal sections and reconstruct corresponding vertical sections.

The lateral actuator system 340 may be formed on a chip having a size of 3×3 mm2. The mirror 342 is mounted on a gimbal frame 341 to minimize cross-talk between axes, i.e., between the inner and outer axes drives. The lateral actuator system 340 operates at an increased resonant frequency in order to scan at higher frame rates. Orthogonal sets of electrostatic comb-drive actuators 345 are coupled to the inner and outer torsional legs or springs 344a, 344b and determine the resonant frequencies of the scanner, based on their shape and configuration. Large scan angles can be achieved with either a downsweep or an upsweep, but greater deflection angles are achieved with a downsweep. For both the X-axis and the Y-axis, in the illustrated example, the lateral MEMS stage 140 can achieve >5° mechanical scan angle at 60 Vpp with a drive frequency close to 8.2 kHz and 2 kHz. Drive frequencies of 8570 Hz and 2100 Hz were used to produce actual tilt frequencies of 4285 Hz and 1050 Hz in the X and Y axes, respectively. The result was a dense Lissajous scan pattern that repeated itself at 5 Hz to encompass images with dimensions of 400×400 pixels with 100% coverage for a FOV of 250×250 μm2.

In some examples, a control system can be configured to achieve Lissajous scanning. Due to increased actuator motion uniformity, Lissajous scanning is used if the axial mirror scanning frequency is too close to the lateral mirror scanning frequency. By tailoring the axial actuator designs to operate at specific frequencies, a fast Lissajous frame rate is obtained.

FIG. 4 illustrates a design for an axial MEMS stage 430. The design can accommodate additional square actuators onto a silicon wafer. A central mirror or mirror platform 432 is supported by four serpentine piezoelectric bending beams, legs, or actuators 435, with piezoelectric stack materials varied to produce selective bend-up or bend-down motion in successive segments of the beams 435. This results in well-defined vertical translation of the mirror surface 432, further enforced by symmetry of the structure in ideal conditions.

The axial MEMS stage 430 has overall dimensions of approximately 3 mm×3 mm×0.5 mm, for eventual integration into 5 mm diameter or smaller endomicroscopy instrument, and an actuator 435 design including four 1.2 mm long individual beams to produce about 400 μm of vertical (i.e., out of plane) displacement along the optical axis to create images in a plane perpendicular to the tissue surface with a natural frequency of about 100 Hz. The actuators 435 are operated near-resonance, with Lissajous scanning used to extract images from the combined motion of the vertical piezoelectric actuators and an in-plane electrostatic scanning mirror. Use of resonant operation enables large scanning range at low voltages, as well as dynamic balancing of the mirror for uniform vertical motion even with a just a single input to the four actuation legs.

The foregoing description demonstrates a novel multiphoton microscope that uses a remote scan configuration and MEMS scanners to provide real time switchable XY/XZ imaging. The axial MEMS scanner works under resonant mode with mechanical resonant frequency of around 440 Hz, resulting in a line scan rate of 880 Hz for a range of 200 um. This high speed axial scanning technique could be used to study fast biological processes, such as action potentials between neurons, in live animals. Although ultra-fast pulses are focused onto the axial MEMS, no signs of damage of the mirror surface were observed after an hour of exposure under 50 mW laser power. The damage threshold could be further improved by changing the mirror coating from aluminum to gold. The lateral MEMS scanner also operates under resonant mode with resonant frequencies of around 4 kHz and 1 kHz for the inner and outer axes. Lissajous scanning was used for both horizontal or vertical plane imaging, with FOVs of 250 μm×250 μm and 250 μm×200 μm respectively and a frame rate of 5 Hz. These MEMS scanners are extremely compact, with footprints about 3 mm×3 mm, while maintaining good mechanical properties. They are also highly reliable, low cost and can be easily mass produced. These MEMS scanners can be good alternatives to the bulky actuators used in conventional microscopes. By using this scanning strategy, it is possible to develop an ultra-compact intravital microscope, or even a miniature device, with real time horizontal and vertical sectioning capabilities. Additionally, in some systems, axial scanning can be completed using electrothermal, electromagnetic, and/or other microactuators in arrangements having similar geometries to the axial scanning actuators described herein, or using electrostatic actuators with offset electrodes to achieve low-frequency (DC) scanning.

In large displacement vertical stages that rely on bending beam architectures, central stage motion can be very sensitive to asymmetries in individual legs, which can result from local variations in residual stress, photolithography misalignment, or other processing non-idealities. One way to deal with non-uniform central stage motion is to calibrate and compensate for asymmetries by applying distinct voltages to two or more legs. Uniform vertical motion can be achieved by identifying frequencies in which contributions from multiple vibration modes produce nearly pure vertical translation, allowing balancing to be performed with just a voltage input to the stage.

The examples of MEMS devices illustrated in FIGS. 3 and 4 are two examples of potential devices for performing axial and lateral scanning as described herein. The MEMS devices of FIGS. 3 and 4, and additional examples of MEMS scanning devices, are described in more detail in U.S. Pat. No. 11,215,805, which is incorporated by reference in its entirety herein.

The optical design of the implanted optics 105 maintains cellular-level lateral and axial resolution across a substantial lateral FOV and large axial range of ˜550 μm. As illustrated in FIG. 1, the microscope uses a folded beam path for axial scanning in which incident light from the input optical fiber 102a is reflected off of a perpendicular mirror surface of the axial MEMS stage 130 before being relayed to the objective 145. The use of the perpendicular surface of the axial MEMS stage 130 allows for control of the focal depth of the imaging while maintaining a small-diameter low-inertial-mass axial scanner. The proposed optical design achieves diffraction limited performance over large FOV areas in a compact form factor (e.g., ˜17 mm×19 mm×8 mm, 2.5 g). The use of a compound objective lens achieves a large working distance for high resolution (e.g., 0.9-1.9 μm lateral resolution, 3.5-8.5 μm axial resolution) imaging across a wide FOV in all three axes.

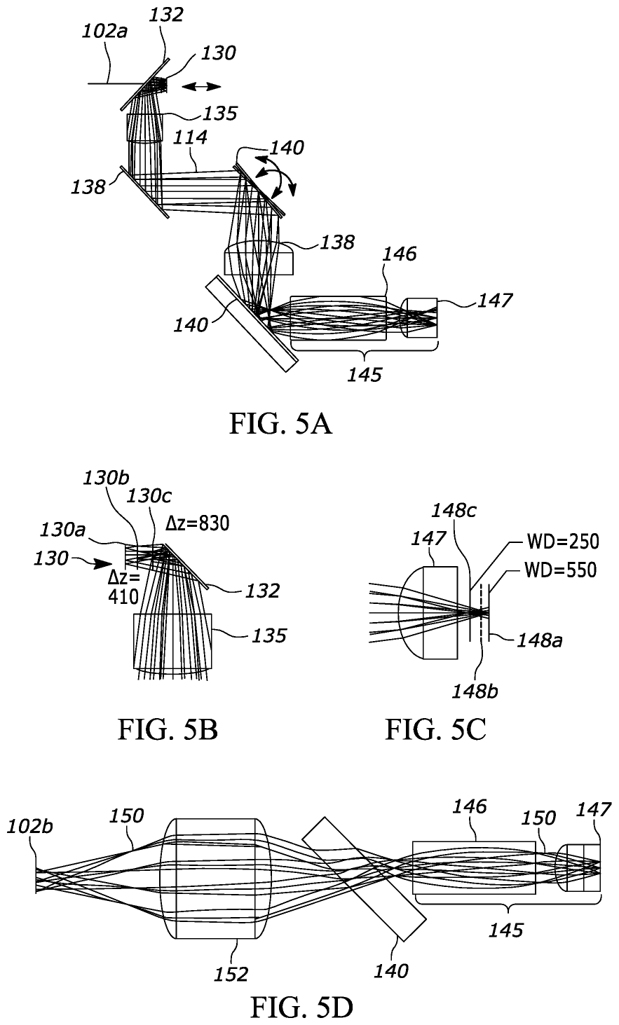

FIG. 5A is a ray diagram of the implanted optics 105 along the path of the excitation radiation 114. Excitation radiation 114 in the form of light from a femtosecond laser (SpectraPhysics MaiTai) is delivered by photonic crystal fiber (PCF) as the input optical fiber 102a, to the axial MEMS stage 130 scanner through a small aperture in the mirror 132. Altering the position of the axial MEMS stage 130 changes the optical path distance from the input optical fiber 102a to a series of lenses, which translates the focal point at the objective 145. Excitation radiation 114 is reflected off the mirror 132 surrounding a ferrule of the input optical fiber 102a, and the excitation radiation propagates through a pair of aspheric lenses, i.e. the first lens 135 and scan lens 139, to the objective 145. The objective 145 has a GRIN lens (Edmund Optics) 146 and aspheric focusing lens 147, which combine to function as a compound lens improving resolution and providing a long imaging working distance. The numerical aperture of the imaging system ranges from 0.41-0.52 across the working distance. The lateral MEMS stage 140 is positioned before (i.e., up-stream) of the scan lens 139 to vary the position of the incident beam on the GRIN lens resulting in the translation of the position of the focus in a transverse plane of the FOV.

FIG. 5B is a ray diagram of the mirror 132, first lens 135, and excitation radiation 114 reflecting off of the axial MEMS stage 130 at three different positions 130a, 130b, and 130c of the axial MEMS stage 130. The first axial MEMS stage position 130a provides the longest optical path for the excitation radiation 114, while a third MEMS stage position 130c provides the shortest optical path. FIG. 5C is a ray diagram showing three different imaging planes 148a, 148b, and 148c resulting from the axial MEMS stage positions 130a, 130b, and 130c, respectively. A first imaging plane position 130a has a working distance of 550 resulting from the first axial MEMS stage position 130a. Similarly second and third imaging plane positions 148b and 148c respectively have working distances of 350 μm and 250 μm resulting from the second and third axial MEMS stage positions 130b and 130c.

FIG. 5D is a ray diagram of implanted optics along the path of the emitted radiation 150, as referred to as the collection path. After the excitation radiation 114 is provided to the sample at a given working distance, the sample fluoresces and provides emitted radiation 150 to the aspheric focusing lens 147. The emitted radiation 150 propagates through the objective (including GRIN lens) 145 and the dichroic mirror 140 transmits the shorter wavelength emitted radiation 150 into a emitted radiation collection path where it is focused by the aspheric lens 150 onto a multi-mode fiber (MMF) as the output optical fiber 102b, for transmission to a photodetector as described with reference to the benchtop portion 110 of FIG. 1.

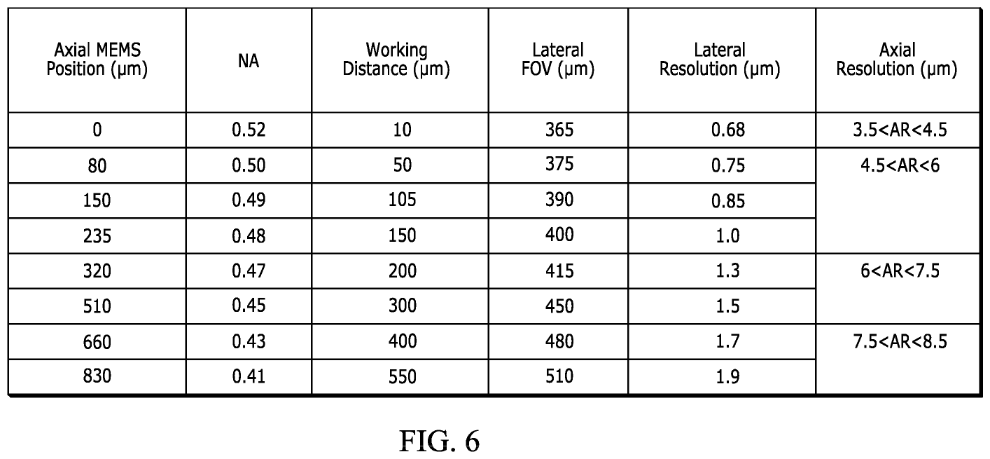

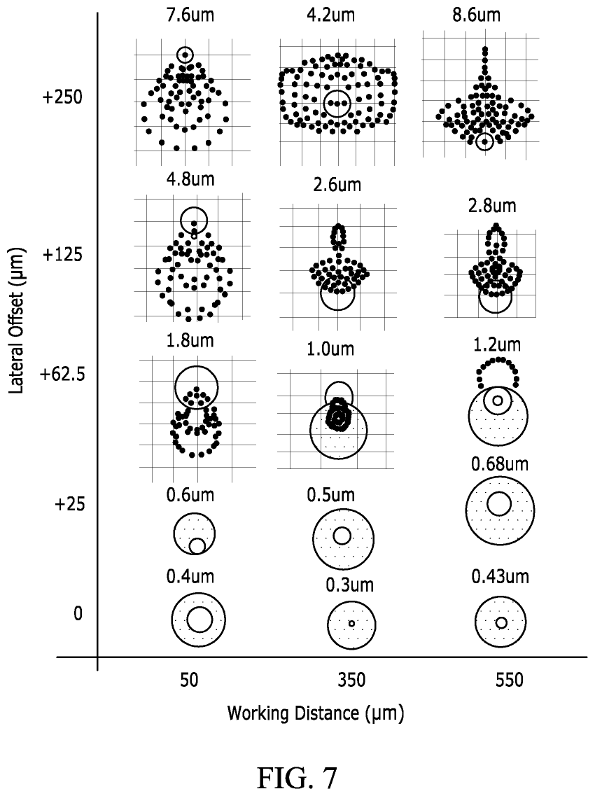

Each of the ray diagrams of FIGS. 5A-5D were simulated using Zemax software. FIG. 6 summarizes the Zemax simulation results for the proposed microscope, and FIG. 7 presents a series of ray spot diagrams illustrating the spot sizes of the simulated results of FIG. 6. The simulated lateral resolution varied from 0.68 μm at a working distance of 10 μm to 1.9 μm at a working distance of 550 μm. The simulated axial resolution varied from 4.5 μm to 8.5 μm over the same working distance range. Diffraction limited performance was maintained on-axis across all simulated working distances. The proposed optical design optimizes performance of the microscope for working distances between 250 and 400 μm, for which diffraction limited resolution is maintained over approximately the central 400 μm of lateral FOV.

In addition to the higher image resolutions, and wider range of working distances, the proposed optical design, as compared to other endoscopic and/or remote imaging setups, eliminates the need for a polarization-maintaining fiber as the input or output fibers 102a and 102b, and removes the requirement of other associated dispersive and refractive optics for controlling polarization of the excitation and/or emitted radiation 114 and 150. This independence from polarization allows for a folded optical path design with less optical components which reduces the overall form factor size and weight of the microscope.

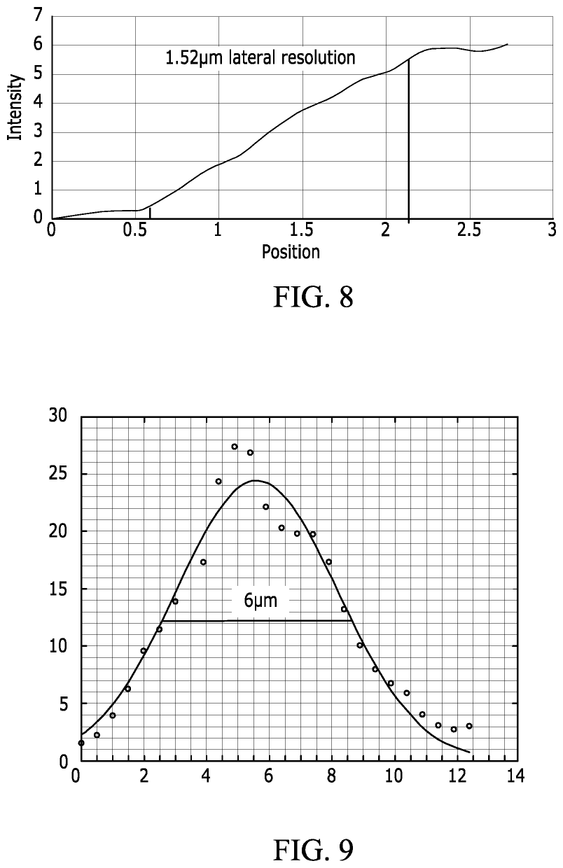

The multi-photon imaging system was fabricated according to the descriptions herein. The lateral and axial resolutions were measured to determine device performance. FIG. 8 is a plot of detected radiation intensity for determining lateral resolution via a knife edge test. In the knife edge test method, 10-90% intensity transition across a sharp edge corresponds to Rayleigh limited resolution. To provide the sharp knife edge border, a standard USAF 1951 resolution target was used. The measure lateral resolution was determined to be 1.5 μm, which is in good agreement with the Zemax simulations. FIG. 9 is a plot of detected radiation intensity for determining axial resolution of the microscope. The measured axial resolution was 6 μm at a working distance of 350 μm, which is again in good agreement with the simulations for the fabricated system and working distance.

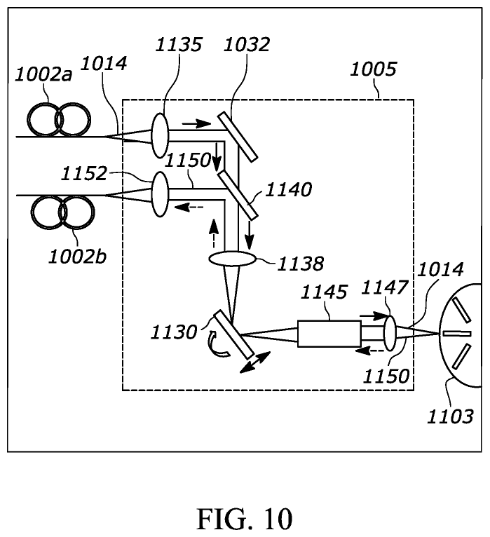

While described in above as having an independent axial MEMS stage, and lateral MEMS stage, the multi-photon optical system 100 of FIG. 1 may be fabricated using a single MEMS stage to perform both axial and lateral scanning. FIG. 10 is a schematic diagram of implanted optics 1005 of a single MEMS stage multi-photon optical imaging system. The implanted optics 1005 of FIG. 10 may be used as the implanted optics in the system 100 of FIG. 1. The single MEMS stage implanted optics 1005 include an input optical fiber 1002a that couples excitation radiation 1014 to the implanted optics 1005. A collimating lens 1135 collimates the excitation radiation 1014 and a first mirror 1032 redirects the excitation radiation 1014 through a dichroic mirror, and a second lens 1138 focuses the excitation radiation 1014 onto an axial and lateral dual MEMS stage 1130. The dual MEMS stage 1130 is capable of scanning the excitation radiation both axially to change a working distance of the microscope optical system, and laterally to image different pixels of a 2D image plane at a specific working distance. The dual MEMS stage 1130 reflect the light into a GRIN lens 1145 which reshapes the excitation radiation 1014 into a focusing lens 1147 that focuses the excitation radiation 1014 into a sample 1103 to image a region of the sample 1103.

Fluorophores in the sample 1103 fluoresce and provide emitted radiation 1150 back to the focusing lens 1147. The GRIN lens 1145 focuses the emitted radiation 1150 onto the dual MEMS stage 1130 which reflects the emitted radiation back through the second lens 1138. In a two-photon emission process, the emitted radiation 1150 has a shorter wavelength than the excitation radiation 1014. The dichroic mirror 1140 reflects the emitted radiation 1150 while the dichroic mirror 1140 is transparent to the excitation radiation 1014 due to the different wavelengths of the different radiations. A coupling lens 1152 couples the emitted radiation 1150 to an output optical fiber 1002b. The output optical fiber 1002b then couples the emitted radiation 1150 benchtop electronics and optical components to detect the emitted radiation 1150 and to generate an image of a region of the sample 1103.

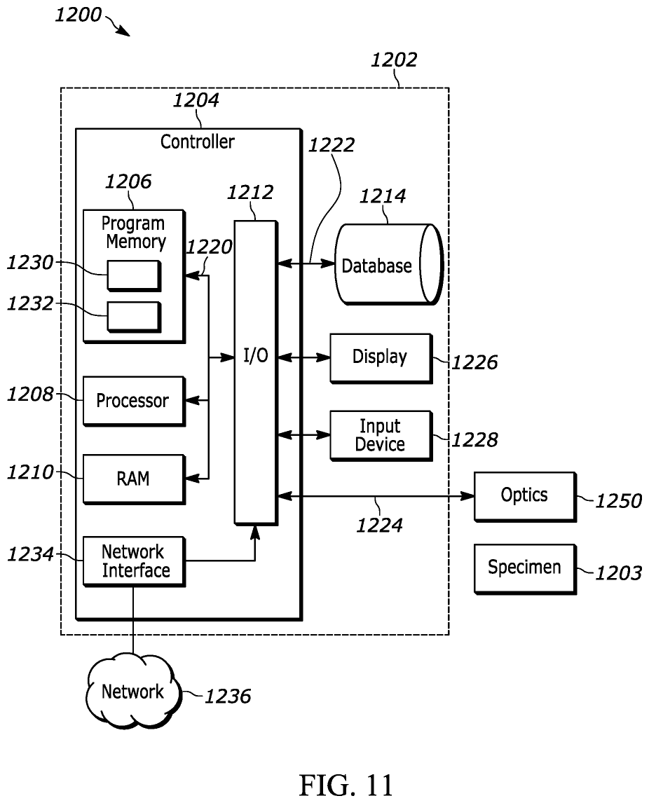

FIG. 11 is an example block diagram 1200 illustrating the various components used in implementing an example embodiment of the thin-film piezoelectric multi-photon microscope system 1202 discussed herein. The implantable optics 1205 previously discussed herein may be positioned adjacent or operatively coupled to a specimen 1203 in accordance with executing the functions of the disclosed embodiments. The system 1202 may have a controller 1204 operatively connected to the database 1214 via a link 1222 connected to an input/output (I/O) circuit 1212. It should be noted that, while not shown, additional databases may be linked to the controller 1204 in a known manner. The controller 1204 includes a program memory 1206, the processor 1208 (may be called a microcontroller or a microprocessor), a random-access memory (RAM) 1210, and the input/output (I/O) circuit 1212, all of which are interconnected via an address/data bus 1220. It should be appreciated that although only one microprocessor 1208 is shown, the controller 1204 may include multiple microprocessors 1208. Similarly, the memory of the controller 1204 may include multiple RAMs 1210 and multiple program memories 1206. Although the I/O circuit 1212 is shown as a single block, it should be appreciated that the I/O circuit 1212 may include a number of different types of I/O circuits. The RAM(s) 1210 and the program memories 1206 may be implemented as semiconductor memories, magnetically readable memories, and/or optically readable memories, for example. A link 1224 may operatively connect the controller 1204 to the optics 1205 through the I/O circuit 1212.

The program memory 1206 and/or the RAM 1210 may store various applications (i.e., machine readable instructions) for execution by the microprocessor 1208. For example, an operating system 1230 may generally control the operation of the endomicroscope system 1202 and provide a user interface to the testing apparatus to implement the processes described herein. The program memory 1206 and/or the RAM 1210 may also store a variety of subroutines 1232 for accessing specific functions of the endomicroscope system 1202. By way of example, and without limitation, the subroutines 1232 may include, among other things: a subroutine for controlling operation of the optical device 1200, or other endoscopic device, as described herein; a subroutine for capturing images with the optics 1205 as described herein; and other subroutines, for example, implementing software keyboard functionality, interfacing with other hardware in the endomicroscope system 1202, etc. The program memory 1206 and/or the RAM 1210 may further store data related to the configuration and/or operation of the endomicroscope system 1202, and/or related to the operation of one or more subroutines. For example, the data may be data gathered by the optics 1205, data determined and/or calculated by the processor 1208, etc.

In addition to the controller 1204, the endomicroscope system 1202 may include other hardware resources. The endomicroscope system 1202 may also be coupled to various types of input/output hardware such as a visual display 1226 and input device(s) 1228 (e.g., keypad, keyboard, etc.) to fine tune actuation of the axial and lateral scanners. In an embodiment, the display 1226 is touch-sensitive, and may cooperate with a software keyboard routine as one of the software routines 1232 to accept user input. The endomicroscope system 1202 may include a network interface 1234 that communicates with an external network 1236 to send or receive data and information on and from the external network 1236.

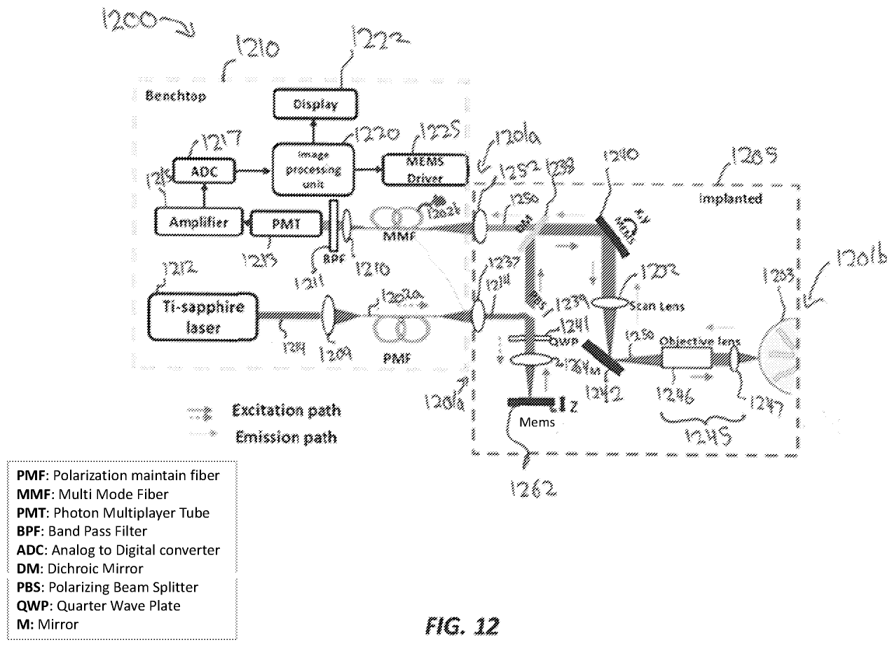

FIG. 12 is a schematic diagram of a miniaturized multi-photon optical imaging system 1200 with miniaturized remote z-scanning using implanted optics 1205 and a benchtop portion 1210. The implanted optics 1205 include a compact Z-scanning unit with a z-scan mirror 1262 and a z-scan lens 1264 with focal length f_{z}. Precise and remote control of the z-scanning depth, while maintaining aberration-reduced, or aberration-free imaging of tissue of a subject can be achieved using the system of FIG. 12. Further, the system 1200 of FIG. 12 provides a compact, miniaturized laser scanning microscopy system capable of remote z-scanning with high precision and aberration-free performance. The system 1200 is capable of imaging at significant working distances and at a diffraction-limited imaging across a wide range of focal plane distances to image various cross-sections or depths of a sample or target. The aberration-free and diffraction limited operation allows for high-resolution imaging which allows for imaging of smaller elements, more intricate structures, and neural activity of tissues such as neurons and brain tissue. Precise imaging of multiple planes in a sample allows for nerd possibilities for studying brain dynamics and functionality.

In examples, the implanted optics 1205 are components that are sized and positioned to be implanted into a biological subject for imaging of tissues in the subject. For example, the subject may be a mouse, and the implanted optics 1205 may be physically positioned within the mouse to image brain tissues of the mouse. The implanted optics 1205 may be contained in a housing (not illustrated) that receives and transmits through ports in a proximal side 1201a of the optics 1205 and is physically connected to the subject or mouse via a distal side 1201b of the implanted optics. An example target for imaging is sample 1203. The implanted optics 1205 include the z-scanning unit 1260 or stage including the z-scan mirror 1262 and z-scan lens 1264, a lateral MEMS scanning unit or stage 1240, and an objective 1245. The lateral scanning unit 1260 may be configured to scan the output laser energy over a planar scan area of the sample 1203 by moving a lateral mirror assembly, and the axial scanning stage 1260 may be adapted to scan the output laser energy over an imaging depth range of the sample. The axial and lateral MEMS stages 1260 and 1240 are also referred to herein as an example of scanning optics. As with other examples herein, the imaging depth range and the planar scan area combine to form a three-dimensional volume, also known as an imaging voxel. The imaging depth may also be referred to herein as a focal distance, focal depth, depth of range, working range, working depth, or working distance of the imaging system 1200. The axial scanning unit 1260, lateral scanning unit 1230, and objective 1245 are all optically coupled to laser and light collection electronics via input and output fiber optic cables 1202a, 1202b. As illustrated, the input fiber optic cable 1202a is the furthest upstream component of the implanted optics, while the output fiber optic cable 1202b is the furthest downstream component of the implanted optics. Any number of these components can be at least partially disposed in a single, handheld probe housing frame (not illustrated), with the probe housing being implanted into the subject.

The benchtop portion 1210 includes laser and light collection electronics such as a Ti-Sapphire laser 1212 with a tunable spectral range of approximately 690-1040 nm. This laser 1212 delivers excitation radiation 1214 with an approximately 100 fs pulse width at 80 MHz, in an example. The pulse duration may be minimized using a dispersion pre-compensation unit located inside the laser housing. A lens 1209 couples the excitation radiation 1214 into the optical fiber 1202a to provide the excitation radiation 1214 to the implanted optics 1205. The benchtop portion 1210 further includes light collection optics to receive and detect the light from the implanted optics 1205. A lens 1210 collects the light from the output optical fiber 1202b, a bandpass filter 1211 filters the light to remove any noise, and a detector 113 then detects the light. The detector 113 may be a photomultiplier tube, a photodiode, or another detector capable of detecting optical radiation. While a Ti-Sapphire laser was used in an implementation, other light sources and imaging processes could be used. For example, a radiation source with excitation radiation wavelengths of up to 1200 nm or 1300 nm could be implemented as the laser 112 for performing three-photon imaging.

The benchtop portion 1210 includes additional hardware components for processing and displaying images. For example, an amplifier 1215 may receive an electrical signal indicative of an image or a pixel from the detector 1213. The amplifier 1215 provides an amplified signal to an ADC 1217. The ADC 1217 provides a digital signal to an image processing unit 1220. The image processing unit 1220 performs image processing to construct images from the digital signal. The image processing unit 1220 may provide image data to a display 1222 and the display 1222 may present images to a user. The image processing unit 1220 may also provide information to a MEMS driver 1225. Depending on the received signal, the MEMS driver may control the positions and/or orientations of the axial and lateral MEMS stages 1260 and 1240.

Once the excitation radiation 1214 has been coupled to the input optical fiber 1202a, the excitation radiation 1202a is provided to a collimating lens 1237, and is reflected off of a polarizing beam splitter (PBS) 1239, and passed through a quarter wave plate 1241 (QWP) through the z-scan lens 1264 to the z-scan mirror 1262 of the axial MEMS stage 1260. The input optical fiber 1202a is configured such that it can be affixed to the subject for imaging. The perpendicular configuration of the input optical fiber 1202a reduces the tension on the input optical fiber 1202 ferule. The z-scan MEMS stage 1260 reflects the excitation radiation 1214 back to the z-scan lens 1264, rotated through the QWP 1241 and transmitted through the PBS 1239. A dichroic mirror 1238 reflects the excitation radiation 1214 to the lateral MEMS stage 1240, and the lateral MEMS stage 1240 reflects the excitation radiation 1214 to a scan lens 1232. The scan lens 1232 focuses the excitation radiation 1214 onto a mirror 1242.

A compound objective lens 1245 further collimates the excitation radiation 1214 to a given spot size and focuses the excitation radiation 1214 into the sample 1203. In various examples, the compound objective lens 1245 combines GRIN lens 1246 with an aspheric focusing lens 1247 to achieve a desired working distance, e.g., a working distance of 350 microns. The GRIN lens 1246 provides a large numerical aperture and working distance across a wide range of lateral positions at which the excitation radiation enters the GRIN lens 1246. The aspheric lens 1247 compensates for spherical aberrations of the GRIN lens, while also further extending the working distance of the probe. The lateral MEMS stage has a ±5° deflection scan angle which results in a field-of-view (FOV) of 400 by 400 μm. In embodiments, the provided optical design may have a FOV of 500 by 500 μm with a working distance of up to 550 μm. In embodiments, the GRIN lens 1246 has a 1.8 mm diameter and 4.31 mm length with a numerical aperture of 0.52 and an effective focal length of 1.69 mm. The GRIN lens 1246 may have a focal length of less than 1.5 mm, less than 1.7 mm, or less than 2 mm to ensure compact size of the implanted optics 105. Further, the GRIN lens 1246 may be a dual wavelength lens to provide similar optical transformations across more than one wavelength region. In embodiments, the aspheric lens 1247 has a 2.4 mm diameter, numerical aperture of 0.54, and an effective focal length of 1.45. The aspheric lens may have a focal length of shorter than 1.4 mm, 1.5 mm, or less than 1.8 mm. The GRIN lens 1246 and the aspheric lens 1247 may each have antireflection coatings such as a visible coating, NIR coating, or broadband antireflective (BBAR) coating to reduce the loss of light through the system.

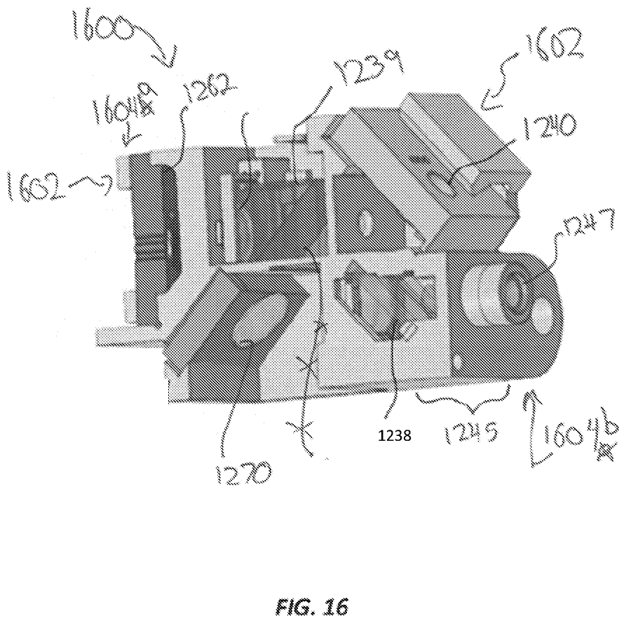

The specific placement of the various optics in the implanted optics 1205 allow for a probe housing 1600 (illustrated in FIG. 16) to be very compact due to the short distances between components. For example, in one fabricated design, the path length of propagation between the lateral MEMS stage 1240 and the GRIN lens 1246 is 6 mm, and the distance from the axial MEMS stage 130 to the GRIN lens 146 is 15 mm. This allows for the housing 1600 to have a height and width of 15 mm by 15 mm at its broadest cross sections for each dimension. Further, the width and length of the probe housing 1600 may be increased or decreased using more or less mirrors to include more propagation in one dimension or the other. In embodiments, the overall size of the probe housing is less than 20 mm by 20 mm, less than 15 by 15 mm, or less than 12 by 12 mm.

The sample 1203 includes fluorophores, such as florescent tags or florescent probes, that fluoresce in response to the presence of a biomolecule such as a protein, antibody, or amino acid. The provided excitation radiation 1214 causes the florescent tags to fluoresce, providing the emitted radiation 1250 from the sample 1203 back to the implanted optics 1205. The emitted radiation 1250 is provided to the lens 1247 which collimates the emitted radiation 1250 back into the objective lens 1245. The emitted radiation 1250 passes through the dichroic mirror 1238 and a lens 1252 focuses the emitted radiation 1250 into the output optical fiber 1202b. The output optical fiber 1202b then provides the emitted radiation 1250 to the lens 1210 and other components of the benchtop portion 1210 for detecting the emitted radiation 1250 and generating an image of the sample 1203. The input and output optical fibers 1202a and 1202b may be single mode fibers, multimode fibers, polarization maintaining fiber, or another fiber capable of coupling light into, and out of, the implanted optics 1205.

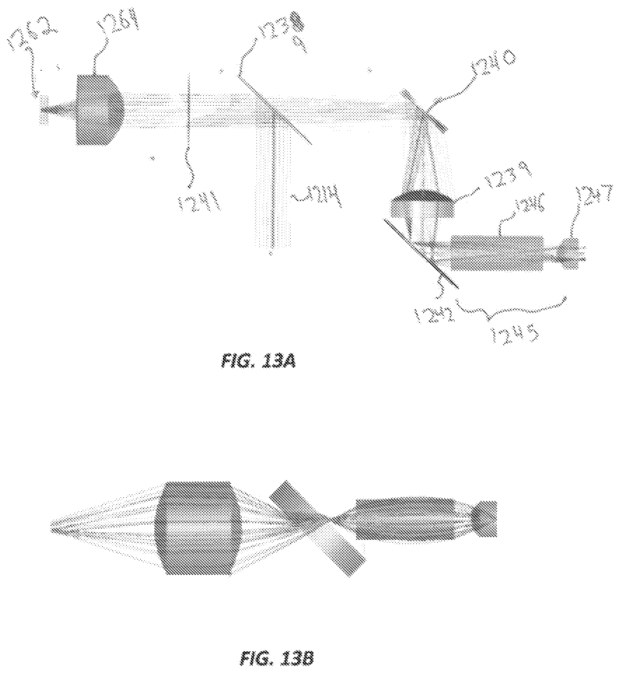

FIG. 13A is a simulated ray diagram showing various elements of the implanted optics 1205 of FIG. 12. The ray diagram shows the path of the excitation radiation 1214 reflecting off of the PBS 1214, through the QWP 1241, focused by the z-scan lens 1264, reflected off of the z-scan mirror 1262, collimated by the z-scan lens 1264, passing through the QWP 1241, passing through the PBS 1239, reflecting off of the lateral MEMS stage 1240, focused by the scan lens 1232, reflected by the mirror 1242, and focused by the GRIN lens 1246 and the aspheric lens 1247. FIG. 13B is a simulated ray diagram showing the path of emitted fluorescence 1250 light through the aspheric lens 1247, GRIN lens 1246, the dichroic mirror 1238, through the lens 1252 and focused into the collection fiber from various points at which the beam may be scanned by the axial and lateral scanners 1262 and 1240.

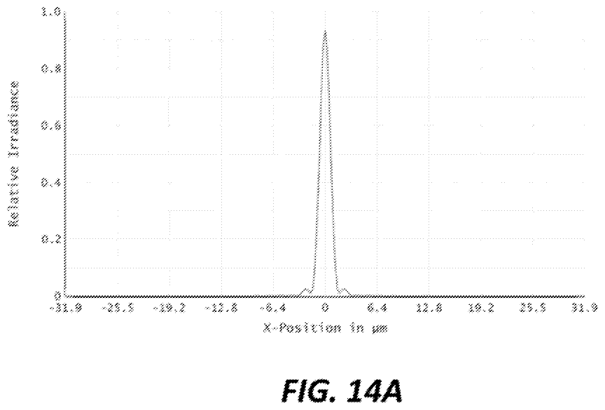

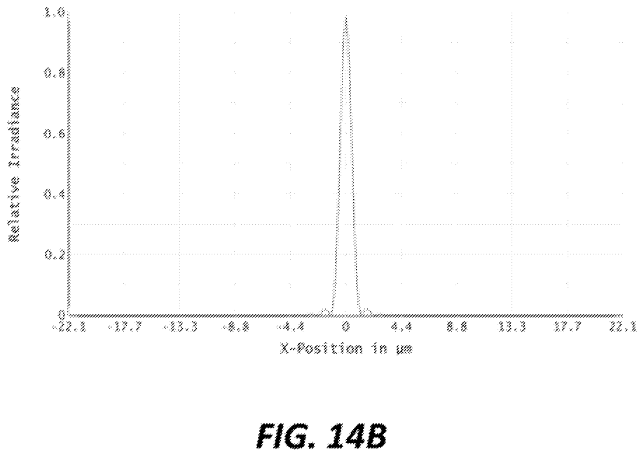

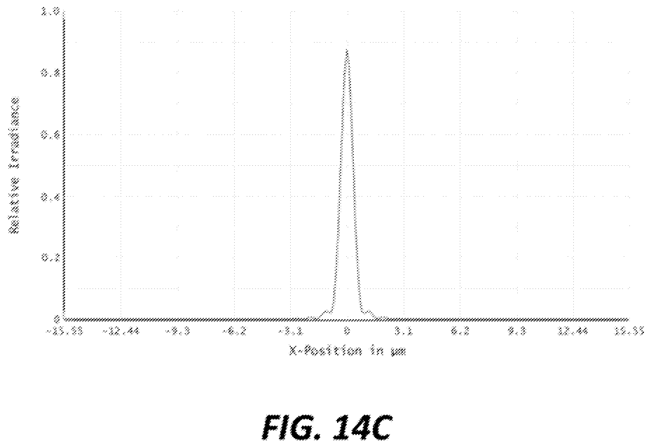

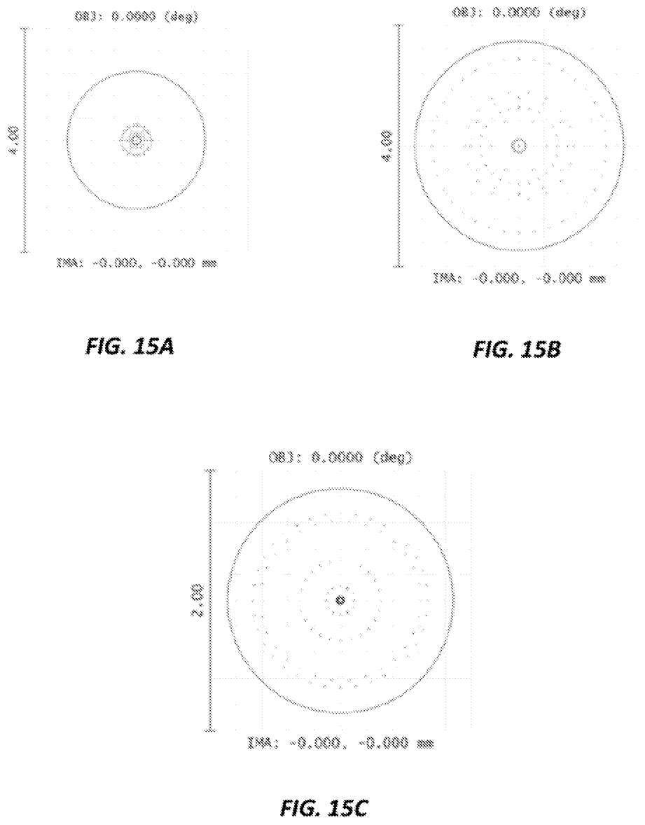

FIGS. 14A, 14B, and 14C are example Point Spread Functions (PSFs) for the focused excitation radiation at three different working distances: 20 μm, 250 μm, and 350 μm. FIGS. 15A, 15B, and 15C are example spot diagrams for the excitation radiation at the same three working distances of 20 μm, 250 μm, and 350 μm. The PSFs and spot diagrams provide valuable insights into the performance of the imaging system. Notably, the diagrams show that the system maintains diffraction-limited resolution over long working distances, (i.e., on the order of hundreds of microns). This diffraction limited resolution is evidenced based on the PSFs and spot sizes within the airy disk. The PSF and spot diagrams offer a visual representation of the system's ability to achieve sharp and focused imaging even at extended working distances, indicating its capability to capture detailed information with high precision.

FIG. 16 illustrates the assembly and test setup 1600 of a two-photon, three-dimensional (3D) imaging system. The setup 1600 may be an example implementation of the system 1200 of FIG. 12. The setup 1600 shows a housing 1602, the dichroic mirror 1238, the lateral MEMS stage 1240, scan mirror 1242, objective lens 1245 with the aspheric lens 1247. An additional mirror 1270 is illustrated to change the direction of the emitted radiation 1250 to focus the emitted radiation 1250 into the collection fiber 1202b. The additional mirror 1270 may be omitted in some implementations. The probe housing 1602 has a proximal end 1604a and a distal end 1604b. During operation, the distal end 1604b of the probe housing 1602 is implanted into the subject such that the implanted optics 1205 are positioned to image the sample 1203 tissue of the subject. The proximal end 1604a of the probe housing 1602 includes input and output ports for the input and output optical fibers 1202a and 1202b respectively. The input and output ports are disposed in one or more walls of the housing 1604 to allow radiation to pass into and out of the housing 1604.

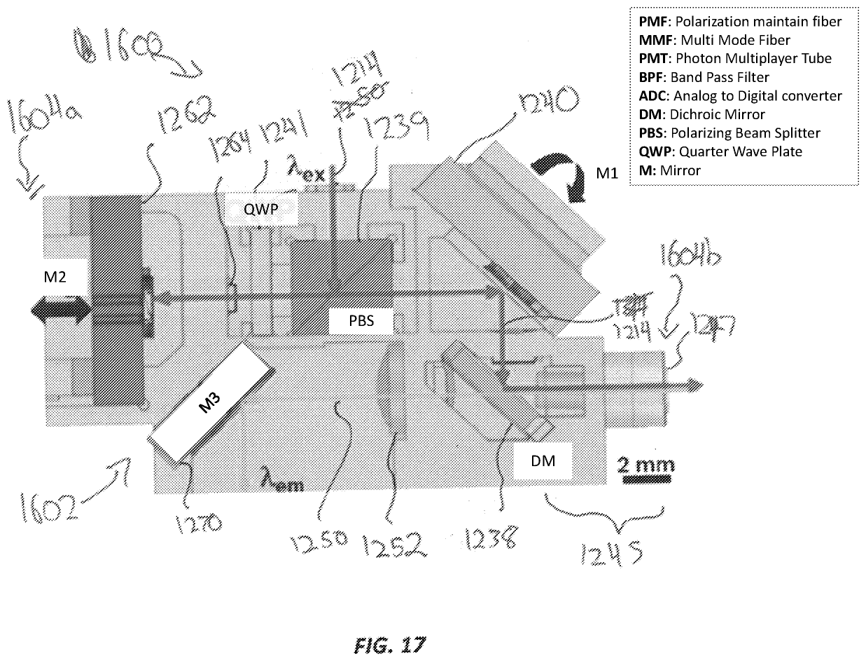

FIG. 17 illustrates a diagram of an optical path through the assembly and test setup 1600 of the miniaturized two-photon, 3D imaging system of FIG. 16. The excitation radiation 1214 enters the setup 1600 and reflects off of the PBS 1239, through the QWP 1241, and is focused by the z-scan lens 1264 onto the z-scan mirror 1262. The excitation radiation 1214 then reflects back through the z-scan lens 1264, is rotated by the QWP 1241 and passes through the PBS 1214. The lateral MEMS stage 1240 and the dichroic mirror 1238 then reflect the excitation radiation 1214 through the objective 1245 and focus the excitation radiation into a sample. The sample emits the emitted radiation 1250 that passes through the objective 1245 and is transmitted through the dichroic mirror 1238. The emitted radiation 1250 is focused by the lens 1252 and is further coupled to the output fiber 1202b via the mirror 1270.

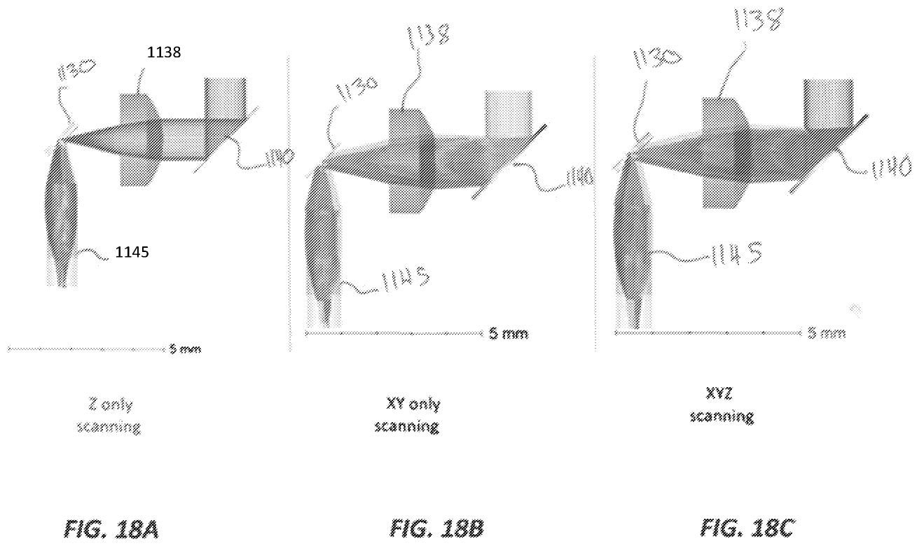

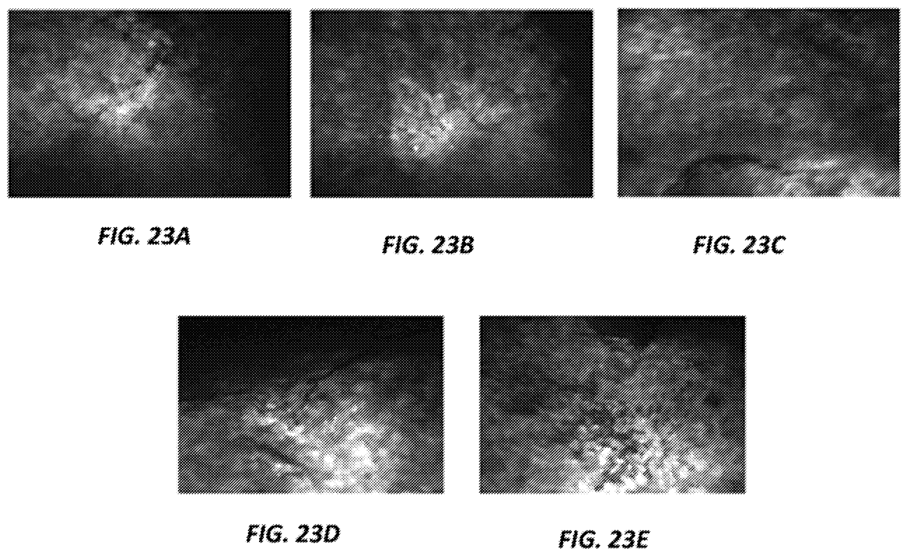

FIGS. 18A-18C are simulated ray diagrams of axial scanning, lateral scanning, and combined axial-lateral scanning MEMS devices respectively. The ray diagrams of FIGS. 18A-18C show the MEMS devices 1130 in the optical configuration of FIG. 10 with the scan lens 1138, mirror 1140, and GRIN lens 1145. FIG. 18A shows that the z-axis translation of the axial scan mirror also moves the focal point of the radiation in a combined axial and lateral path or displacement. FIG. 23B shows that the x- or y-rotation of the lateral MEMS stage 1240 moves the focal point of the radiation primary on a lateral path in a plane along the axis of propagation of radiation. FIG. 23C shows that the combined motion of axial and lateral scanning can scan out an oblique FOV, effectively in a parallelogram in the transverse x-y plane of a sample.

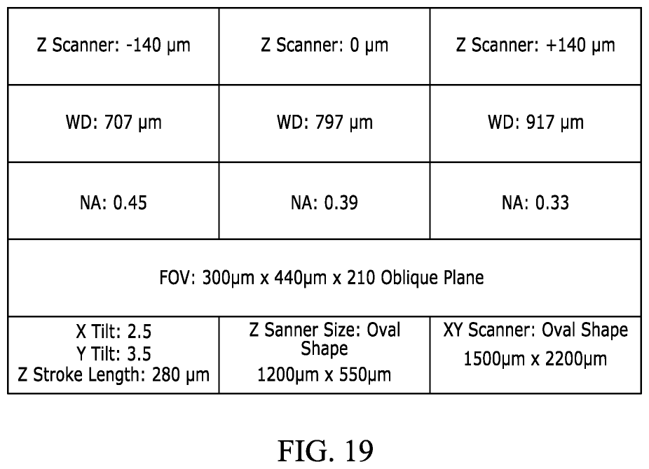

FIG. 19 is a table showing the working distance, numerical aperture, field of view, and the scanner geometries for axial z-scanners at different axial scanner locations. As the scanner moves back or forward from its neutral position (i.e., left and right column versus center column), the working distance changes, as well as the NA. The bottom two-rows are data that applied for all z-scan positions, including the total FOV and the requirements on the scanners to achieve the total FOV. As reported in FIG. 19, the total FOV was a 300 μm×440 μm×210 μm oblique plane. In implementations, a spacer, such as an approximately 700 μm thick glass spacer, may be placed between the distal end of the probe and the sample such that the effective imaging depth inside of the sample may be between about 0-217 μm, while the overall working distance of the optics is larger.

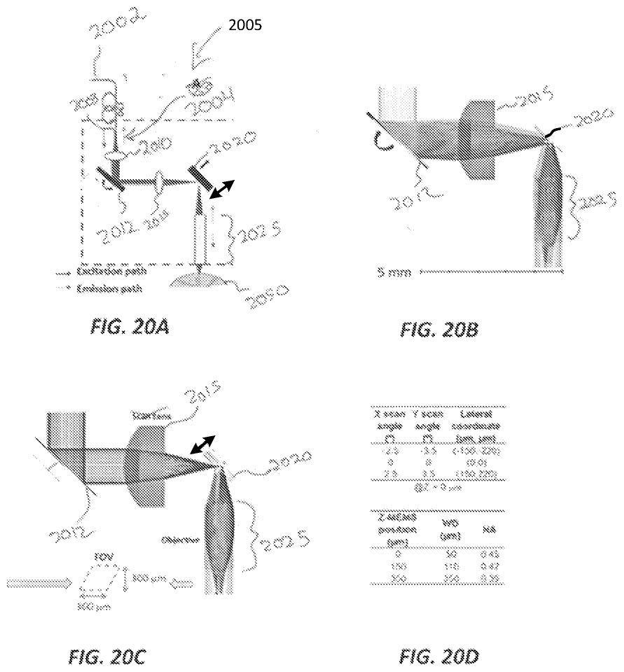

FIG. 20A is a block diagram of implantable optics 2005 with excitation radiation 2003 provided by a Ti:sapphire laser and an input optical fiber 2002. The configuration of FIG. 20A utilizes a single optical fiber 2002 to provide the excitation radiation 2003 and to collect emitted radiation 2004 for further detection and analysis. The excitation radiation 2003 is collimated by a lens 2010 and reflected off of a lateral MEMS stage 2012. The excitation radiation 2003 then passes through a scan lens 2015 and reflects off of an axial MEMS stage 2020 and is focused into a sample 2050 by an objective 2025. FIGS. 20B and 20C are simulated ray diagrams of the objective lens and MEMS stages of the implantable optics 2005 of FIG. 20A showing various lateral MEMS stage 2021 positions, and various axial MEMS stage 2020 positions respectively.

To perform volumetric imaging in deeper brain regions, the objective lens 2025 must be extended to a longer overall length with a smaller diameter. The optical setup of FIGS. 20A-20C demonstrates an optical scanning geometry that achieves a FOV of 300×440×300 μm³ while using a substantially reduced final objective lens 2025 diameter (<1.0 mm), suitable for insertion of up to 1 mm into a mouse cortex without major adverse impact on cortical function. This setup allows for access to the interior of tumors for imaging, and tumor imaging before tumors are sufficiently large to extend into upper brain layers. The design provided in FIGS. 20A-20C is based on GRIN lenses designed for deep tissue imaging. Coupled with the MEMS scanners introduced immediately before the objective lens, this design permits 3-axis laser displacement on the lens for 3D imaging, in contrast to fixed depth fiber bundles or scanning fibers, and the provided design results in much smaller size than dedicate axial scanning modules. Simulated lateral resolution varies from 1 μm at a WD of 50 μm to 2 μm at a WD of 350 μm relative to the surface of the GRIN lens. The simulated axial resolution varies from 9 μm to 12 μm over the same WD range. Compared to remote, dual-MEMS scanning, the design provided in FIGS. 20A-20C can be implemented without a polarization-maintaining PCF and associated dispersive and refractive optics. Instead, a single double-clad fiber 2002 may be used to deliver excitation light and collect fluorescence (i.e., excitation radiation 2004). The NA may be approximately 0.39-0.45 across the FOV. The design provided in FIGS. 20A-20C may reduce system complexity, and result in a smaller instrument size that is suitable for a smaller diameter objective. FIG. 20D is a table of lateral scan angles, with corresponding lateral focus distances or coordinates, in various examples. FIG. 20D further presents axial MEMS positions with corresponding working distances and numerical apertures for the implantable optics 2005 of FIG. 20.

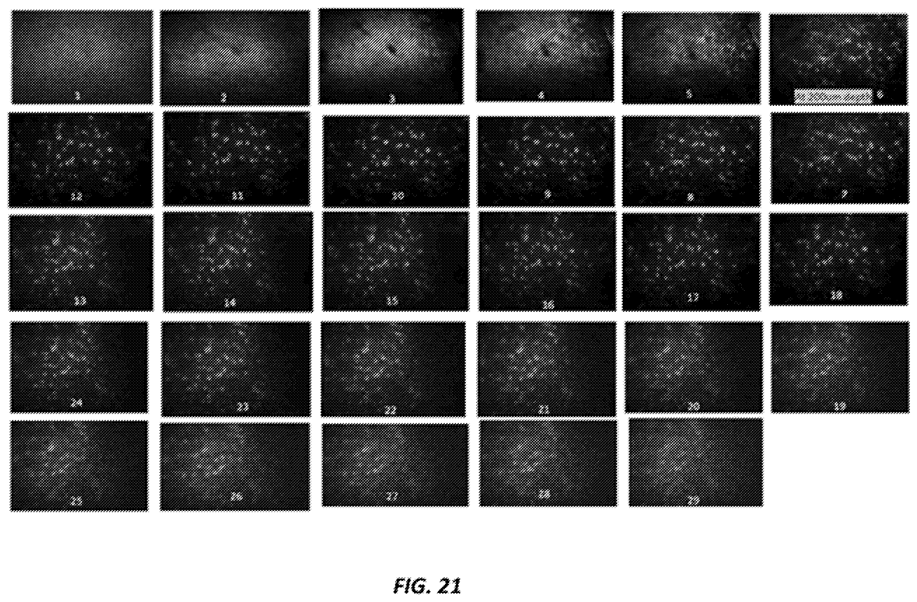

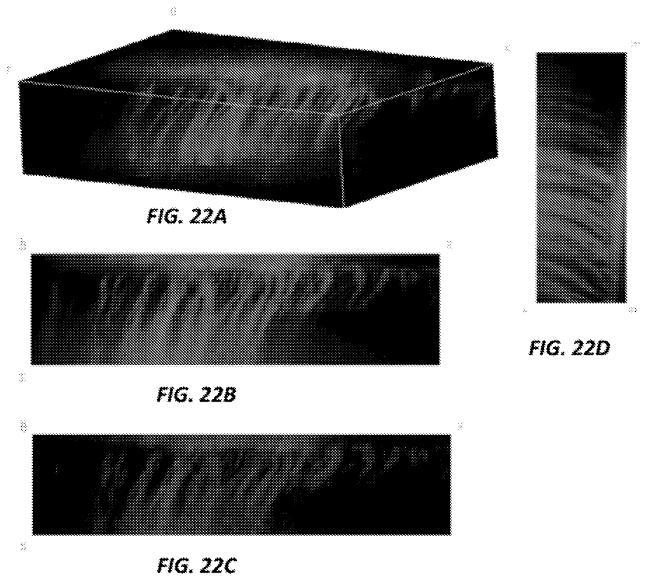

FIG. 21 shows a plurality of ex-vivo images of a Thy1-YFP mouse sample tissue remote axial scanning. Each of the images were taken at different focal distance depths in the tissue sample ranging from about a 250 micron depth to about a 300 microns depth at steps on the order of 10 μm at a time. The images were collected plane-by-plane at the different axial depth slices, and a 3D image volume was reconstructed from the plurality of images. FIG. 22A presents a volumetric image reconstruction of the axial imaging scan presented in the plurality of images of FIG. 21. FIG. 22B presents a side view of a vertical slice of the volumetric image reconstruction presented in FIG. 22A. FIG. 22C presents a second side view of a different vertical slice of the volumetric image reconstruction of FIG. 22A. FIG. 22D presents a slice of the volumetric image reconstruction of FIG. 22A in the y-z plane. FIGS. 22B-22D demonstrate the ability to take vertical slices in either the x-z or y-z planes. The volumetric image reconstruction was performed by aligning the various images of FIG. 21, and stacking the images to stack slices of the volume to create a comprehensive visualization of the axially image volume of the sample. This ex-vivo imaging approach presented allows for the detailed examination of the Thy1-YFP mouse sample at a cellular level. The reconstructed three-dimensional representation provides valuable insights into the spatial arrangement and distribution of YFP-labeled neurons within the sample. This information can be used to further understand and analyze neuronal morphology, connectivity, and organization.

FIGS. 23A-23E are images of a brain tumor sample with green fluorescent protein (GFP) GFP expression using the multi-photon imaging systems described herein. The images of FIGS. 23A-23E were obtained using the setup illustrated in FIG. 22 with at a single depth at various transverse locations in the XY plane. The images were obtained from post-mortem brain tissue samples with GFP expression in a brain tumor at different locations of the sample. The imaged sample enables a multi-focal plane visualization and allows for the study of characteristics of the tumor at a microscopic level. For example, post-mortem imaging allows for detailed examination of a tumor's spatial distribution, cellular features, and interactions within the surrounding brain tissue. Imaging GFP expression within the tumor allows researchers to gain insight into a tumor's extent, localization, and potential interactions with neighboring cells. This information contributes to a better understanding of tumor biology and can aid in the development of targeted therapeutic strategies. The post-mortem imaging approach provides a valuable tool for investigating the molecular and cellular aspects of brain tumors, paving the way for advancements in tumor research and treatment.

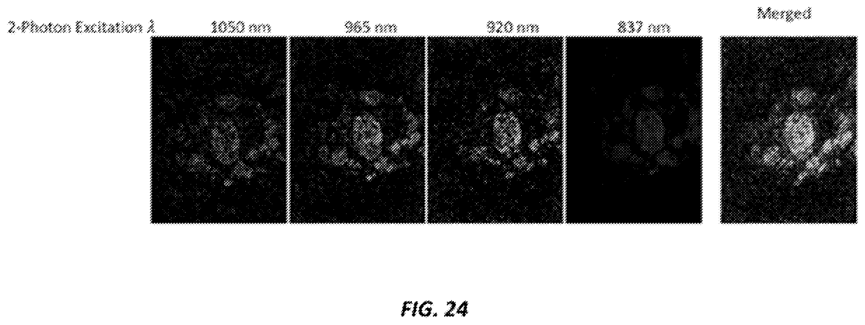

FIG. 24 presents ex-vivo images of an animal sample using multiwavelength excitation of a confetti mouse fallopian tube. Various excitation radiation wavelengths were used to excite the different markers. The excitation wavelengths used were 1050 nm, 920 nm, 965 nm, and 837 nm. The use of the 1050 nm laser wavelength allowed for deep tissue penetration, enabling imaging at greater depths within the fallopian tube. The 1050 nm wavelength range is particularly advantageous for imaging thick samples or structures located deeper within the tissue. The 920 nm, 965 nm, and 837 nm laser wavelengths were employed to selectively excite specific fluorophores within the confetti mouse fallopian tube. These different wavelengths enabled the discrimination and visualization of distinct fluorescence patterns emitted by different cell populations labeled with different fluorophores. Testing the system with multiple laser wavelengths on the fallopian tube from a confetti mouse provided valuable insights into the system's capabilities for multi-color imaging and its ability to effectively visualize and distinguish different fluorophores within complex samples. As evidenced by the images of FIG. 24F, the system demonstrates a capability to excite and effectively operate with a wide range of laser wavelengths. Additional wavelength and light filtering may be added to the system to further improve image resolution, brightness, SNR, and clarity.

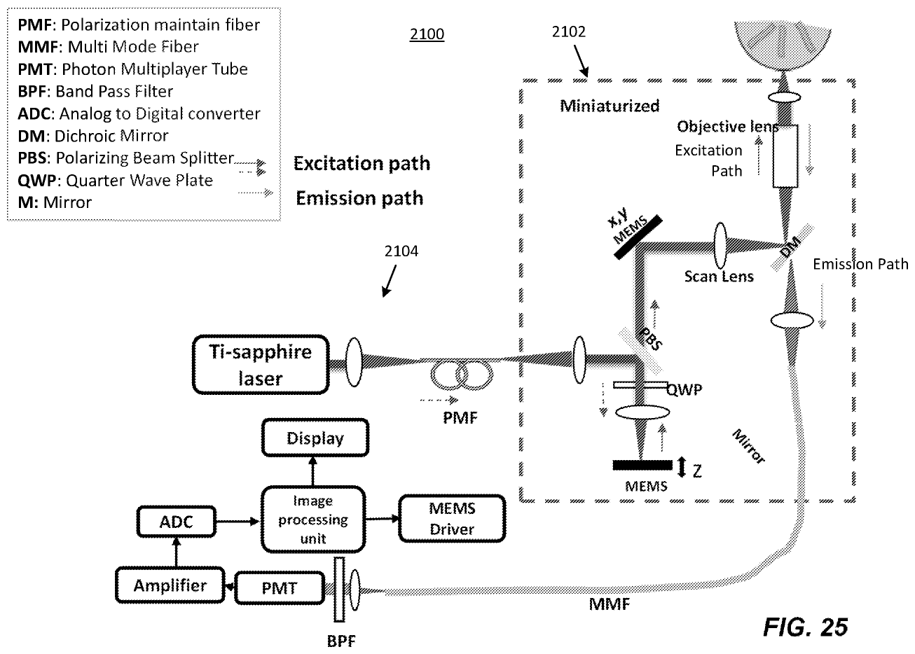

FIG. 25 illustrates another example miniaturized multi-photon optical imaging system 2100 with a miniaturized remote z-scanning using implanted optics 2102 and a benchtop portion 2104. The image system 2100 is configured for air-coupling and has a focusing lens for an emission path, where the emission path before the PMT does not pass through the scan lens for the excitation path, nor does the emission path reflect off of a MEMS mirror, thereby avoiding potential signal strength reduction.

Throughout this specification. plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the target matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting.” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding; and no unnecessary limitations should be understood therefrom, as modifications within the scope of the invention may be apparent to those having ordinary skill in the art.

What is claimed:

1. An implantable multi-photon optical probe comprising:
a probe housing having a proximal end and a distal end implantable on a sample, the probe housing configured to provide excitation radiation to the sample and to collect emitted radiation from the sample;
an input optical fiber port in a wall of the probe housing, the input optical fiber port having an input optical fiber deposed therein, with the input optical fiber configured to guide the excitation radiation into the probe housing from outside of the probe housing, through a wall of the probe housing:
scanning optics disposed in the probe housing, the scanning optics configured to receive the excitation radiation and to (i) laterally scan the excitation radiation over a field-of-view of the optical probe, and (ii) axially scan the excitation radiation over a range of imaging depths of the optical probe;
a scanning lens disposed in the probe housing to receive the excitation radiation from the scanning optics, the scanning lens configured to collect the excitation radiation to focus the excitation radiation; and
an objective lens disposed in the probe housing to receive the excitation radiation from the scanning lens, the objective lens being disposed in the probe housing and configured to reshape and focus the excitation radiation into the sample.

2. The optical probe of claim 1, wherein the objective lens comprises a graded index lens.

3. The optical probe of claim 1, wherein the objective lens comprises an aspheric lens that corrects for aberrations, and further focuses the excitation radiation into the sample.

4. The optical probe of claim 1, wherein the scanning optics comprises:
an axial scanning stage disposed in the probe housing, the axial scanning stage configured to scan the excitation radiation over an imaging depth range of the sample; and
a lateral scanning stage disposed in the probe housing, the lateral scanning stage adapted to scan the excitation radiation over a planar scan area of the sample, wherein the imaging depth range and the planar scan area form a three-dimensional volume being the field-of-view of the optical probe over multiple imaging depths.

5. The optical probe of claim 4, further comprising a first lens disposed between the axial scanning stage and the lateral scanning stage, the first lens configured to collimate the excitation radiation or to partially collimate the excitation radiation, within 5 degrees or less, 10 degrees or less, or 20 or less of collimation.

6. The optical probe of claim 1, wherein the scanning optics comprises a single lateral-axial scanning stage disposed in the probe housing, the later-axial scanning stage adapted to scan the excitation radiation over a planar scan area of the sample, and over a depth of range of the sample, wherein the depth of range and the planar scan area form a three-dimensional volume including a field-of-view and imaging depth range of the optical probe.

7. The optical probe of claim 1, further comprising an output optical fiber port having an output optical fiber disposed therein, the output optical fiber configured to guide the emitted radiation from inside of the probe housing to outside of the probe housing through a wall of the probe housing.

8. The optical probe of claim 1, wherein the distance from the scanning optics to the objective lens is less than 20 mm.

9. The optical probe of claim 1, wherein the focusing lens comprises an aspheric lens that corrects for aberrations caused by the objective lens.

10. The optical probe of claim 1, wherein the objective lens comprises:
a graded index lens disposed between the scanning optics and the sample; and
a focusing lens disposed between the graded index lens and the sample.

11. The optical probe of claim 1, wherein the objective lens comprises:
an graded index lens having an effective focal length shorter than 2 mm; and
an aspheric lens having an effective focal length of less than 1.5 mm.

12. The optical probe of claim 1, wherein the objective lens is disposed between the scanning optics and the sample.

13. The optical probe of claim 1, wherein at least one component of the objective lens has a visible wavelength anti-reflection coating.

14. The optical probe of claim 1, further comprising an axial scanning stage disposed in the probe housing, the axial scanning stage configured to scan the excitation radiation over an imaging depth range of the sample;
a polarizing beam splitter disposed upstream of the axial scanning stage, the polarizing beam splitter disposed and oriented (i) to receive the excitation radiation and (ii) to provide the excitation radiation to the axial scanner stage; and
a waveplate disposed between the polarizing beam splitter and the axial scanning stage to rotate the polarization of the excitation radiation.
